(19) United States
(12) Patent Application Publication
(10) Pub. No.: US 2021/0368833 A1
(43) Pub. Date: Dec. 2, 2021

(54) STABILIZED FROZEN PRODUCE

(71) Applicant: Washington State University, Pullman, WA (US)

(72) Inventors: Shyam S. Sablani, Pullman, WA (US); Joseph R. Powers, Pullman, WA (US)

(21) Appl. No.: 17/329,217

(22) Filed: May 25, 2021

Related U.S. Application Data
(60) Provisional application No. 63/031,017, filed on May 28, 2020.

(51) Int. Cl. A23L 3/375; A23L 3/3562; A23L 3/44; A23L 29/256; A23L 29/262

(52) U.S. Cl. CPC A23L 3/375; A23L 3/3562; A23L 29/262; A23L 29/256; A23L 3/44

(57) ABSTRACT

Methods of stabilizing produce, such as fruits and vegetables, are provided. In particular, the methods comprise vacuum impregnating the item of produce in an infusion solution containing a polysaccharide, partially drying the item of produce to reduce its water content below its original harvest-level of hydration, and optionally applying an edible coating to the item of produce. Subsequently frozen items of produce display improved mechanical properties and visual integrity.

### CROSS-REFERENCE TO RELATED APPLICATIONS

This application claims priority to U.S. patent application 63/031,017, filed May 28, 2020, the contents of which are herein incorporated by reference.

### STATEMENT OF FEDERALLY SPONSORED RESEARCH AND DEVELOPMENT

This invention was made with government support under Cooperative Agreement 15-SCBGP-WA-0017 awarded by the United States Department of Agriculture through the Agricultural Marketing Service under subaward K1772 from the Washington State Department of Agriculture. The government has certain rights in the invention.

### FIELD OF THE INVENTION

The invention generally relates to improved methods of maintaining the firmness and visual integrity of fruits and vegetables after freezing and thawing. Component processes include vacuum impregnation (VI), application of edible coatings, and dehydrofreezing.

### BACKGROUND OF THE INVENTION

Food manufacturers (e.g., bakeries and dairies) incorporate whole or diced produce (i.e., not pureed) in various products. Traditional preservation methods—such as freezing and drying—accommodate both a limited growing season and inherent challenges of transporting perishable fresh produce from distant regions. Existing preservation methods work well for some fruits. For example, frozen and dried blueberries are popular in muffins, and strawberries are successfully used in ice cream. Other produce is not as hardy, tending to breakdown when thawed or mixed, due to a combination of compound structure, pulp composition, and/or skin characteristics. This can result in food with reduced aesthetic and textural qualities. Red raspberries exemplify this fragility, tending to bleed when used whole in baked goods. Likewise, while many vegetables freeze well, rhubarb tend to exhibit high levels of lysis.

Several methods have been developed separately to fortify foods and address various challenges in preserving produce. Dehydrofreezing reduces cellular water content so ice crystals have more room to expand within cells, reducing the damaging effects of freezing. In delicate, high-moisture fruits, even after partial dehydration, freezing can cause significant cellular damage resulting in a loss in turgidity and firmness of thawed fruit. Vacuum impregnation (VI) adds pectin solution or other food grade firming agents, while porous membranes remain intact. Finally, edible coatings have been used to change barrier properties. However, none of these applications have provided sufficient stability after freezing to particularly delicate, high moisture produce such as red raspberries. Thus, improved methods of stabilizing frozen produce are needed.

### SUMMARY

Embodiments of the disclosure provide methods of stabilizing produce in preparation of freezing comprising a combination of vacuum-impregnation, partial dehydration, and application of edible coatings. The combined processes synergistically improve structural and visual integrity of the frozen and thawed produce. The resulting produce is baking-stable due to a minimization in syneresis.

One aspect of the disclosure provides a method of stabilizing produce, comprising submerging an item of produce in an infusion solution comprising a polysaccharide and optionally a divalent cation, applying a vacuum to the infusion solution containing the item of produce, releasing the vacuum applied to the infusion solution, removing the item of produce from the infusion solution, drying the item of produce after infusion so as to reduce a water content of the item of produce below an original harvest-level of hydration of the item of produce, and optionally applying an edible coating to the item of produce.

In some embodiments, the polysaccharide is a pectin such as low methoxyl pectin (LMP). In some embodiments, the polysaccharide is present at a concentration of 0.8-1.2% w/w. In some embodiments, the infusion solution further comprises calcium chloride. In some embodiments, the calcium chloride is present at a concentration of 0.025-0.040 mg per g of polysaccharide. In some embodiments, the infusion solution is maintained at a temperature of 18-22° C. during the applying step. In some embodiments, the item of produce is air dried at a temperature of 62-68° C. and an air velocity of at least 1.3 m/s.

In further embodiments, if an edible coating is applied, the edible coating comprises sodium alginate or sodium carboxymethylcellulose. In some embodiments, the sodium alginate is at a concentration of 0.2-0.6% w/v. In some embodiments, the sodium carboxymethylcellulose is at a concentration of 0.03-0.07% w/v. In some embodiments, the method further comprises a step of air blast freezing the item of produce after partially drying the produce or after applying the edible coating. In some embodiments, the item of produce is frozen to a temperature at or below −18° C.

Other features and advantages of the present invention will be set forth in the description of invention that follows, and in part will be apparent from the description or may be learned by practice of the invention. The invention will be realized and attained by the compositions and methods particularly pointed out in the written description and claims hereof.

### BRIEF DESCRIPTION OF THE DRAWINGS

FIG. 1. Flow diagram of a process according to some embodiments of the disclosure, with fresh produce, polysaccharide solution, and edible coating as inputs, along with component processes.

FIGS. 2A-B. Process flow diagram, (a) Stage 1: Identification of the optimal conditions for partial drying (PD) and freezing (FR). (b) Stage 2: Development of vacuum impregnated dehydrofrozen berries.

FIGS. 3A-L. Effect of drying conditions on visual integrity of red raspberries, (a to c) control samples i.e. fresh red raspberries; (d to f) dried at air temperature of 65° C. to different level of water contents; (g to i) dried at air temperature of 60° C. to different level of water contents; (j to l) osmotic dehydration (OD) plus air drying (AD), temperature of the osmotic solution 30° C., 5 h immersion time to reach 0.7 g water g⁻¹ fruit, air temperature 65° C. Berry (j) was only osmotic dehydrated.

FIG. 4. Variation of the soluble solids content with time during osmotic dehydration of red raspberries at different temperatures in sucrose solutions. Total soluble solids at t=0; 10.65° Brix; t=5 h; 16° Brix. Results reported are mean±SD of three replicates. Every replicate involved 10 raspberries.

FIG. 5. Effect of the air-blast and cryogenic freezing treatments on raspberries. Frozen-thawed raspberries after two months storage. Air temperatures of 65 and 60° C. to achieve 0.70, 0.65, 0.60 g of water g⁻¹ of fruit. Osmotic dehydration plus air drying (OD+AD).

FIG. 6. Effect of the air-drying temperature and freezing rate on firmness of raspberries; maximum force F_{M}. Results reported are mean±SD of three replicates. Every replicate involved 10 raspberries

FIG. 7. Effect of the air-drying temperature and freezing rate on firmness of raspberries; gradient G_{C}. Results reported are mean±SD of three replicates. Each replicate involved 10 raspberries.

FIGS. 8A-B. First stage; a) Performance evaluation of the edible coatings on non-dried frozen thawed raspberries. b) Performance evaluation of the edible coatings on partially dried-frozen thawed raspberries.

FIG. 9. Performing evaluation of vacuum impregnated, partially dried and coated frozen raspberries after thawing and baking.

FIG. 10. Determination of syneresis in muffins. A1 represents the area of the berry. A2 represents the area of the berry plus the area of juice bleeding from the berry.

FIG. 11. Weight loss in fresh and coated raspberries during storage at 4° C. for 5 days. Means within the same day followed by the same letters are not significantly different at p≤0.05.

FIG. 12. Visual integrity of frozen thawed raspberries. First row; non dried berries with and without coatings. Second row; dried berries to a water content of 0.65 g of H₂O/g of fruit with and without coatings.

FIG. 13. Maximum force, F_{M} in treated red raspberries after thawing. VI vacuum impregnated raspberries. VI-PD vacuum impregnated and partially dehydrated berries. Results reported are mean±SD. Values with a different letter are significantly different (p≤0.05).

FIG. 14. Gradient G_{C} in treated red raspberries after thawing. VI vacuum impregnated raspberries. VI-PD vacuum impregnated and partially dehydrated berries. Results reported are mean±SD. Values with a different letter are significantly different (p≤0.05).

FIG. 15. Drip loss in treated red raspberries after thawing. VI vacuum impregnated raspberries. VI-PD vacuum impregnated and partially dehydrated berries. Results reported are mean±SD. Values with a different letter are significantly different (p≤0.05).

FIGS. 16A-G. Syneresis in baked red raspberries muffins. (a) Commercially frozen; (b) VI vacuum impregnated only; (c) PD partially dried only; (d) VI-PD vacuum impregnated and partially dried; (e) VI-PD-EC CMC L vacuum impregnated, partially dried and coated with low concentration of carboxymethylcellulose; (f) VI-PD-EC CMC H vacuum impregnated, partially dried and coated with high concentration of carboxymethylcellulose; and (g) VI-PD-EC SA L vacuum impregnated, partially dried and coated with low concentration of sodium alginate.

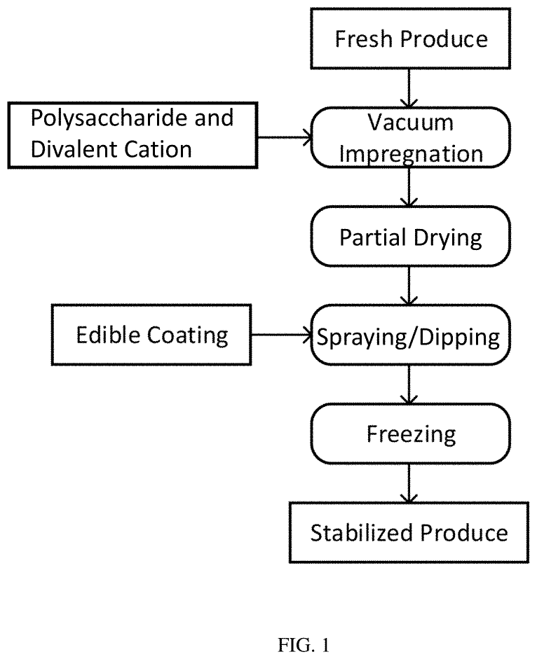

### DETAILED DESCRIPTION

The present disclosure provides methods for enhancing the stability of produce subjected to frozen storage. In some embodiments, the item of produce is stabilized for at least two months.

The term “produce” refers to food products such as fruits and vegetables and plants or plant-derived materials that are typically sold uncooked and, often, unpackaged, and that can sometimes be eaten raw. Exemplary types of produce include, but are not limited to: stone fruit or drupe (e.g. plum, cherry, peach, apricot, olive, mango, etc.); pome fruits of the family Rosaceae, (including apples, pears, rosehips, saskatoon berry, etc.); aggregate fruits such as achenes (e.g. strawberry), follicles, drupelets (raspberry, such as Rubus berries, and blackberry), and various other berries; multiple fruits such as pineapple, fig, mulberry, osage-orange, breadfruit, hedge apple, etc; citrus fruits such as oranges, lemons limes, grapefruits, kumquats, tangelos, ugli fruit, tangerines, tangelos, minnolas, etc.; so-called “true” berries such as black current, red current, gooseberry, tomato, eggplant, guava, lucuma, chilis, pomegranates, kiwi fruit, grape, cranberry, blueberry, etc.; including both seeded and seedless varieties, as well as hybrid and genetically altered or manipulated varieties; and others such as avocados, persimmons; bell peppers; broccoli; lettuce; peas; zucchini; celery; or other similar produce that can benefit from enhanced stability, prior to freezing. In some embodiments, the item of produce comprises at least one of whole fruit, whole vegetable, portion of a fruit, and portion of a vegetable.

The methods of the disclosure enhance stability by increasing or maintaining the firmness of produce after freezing and thawing. Firmness is a textural sensory attribute used to describe the resistance to breaking of a solid food product when it is eaten. Firmness depends on such factors as the degree of ripeness, fibrousness, turgidity, and processing, and can be assessed by instrumental or sensory tests such as compression and penetration. Maximum force (FM) is defined as the peak force that occurs during the first compression cycle. Gradient (GC) is the slope of the curve in the linear zone prior to rupture point. FM and GC can be used to measure firmness of produce. In some embodiments, the methods provide produce having a FM of at least about 0.5 kgf, e.g. at least about 0.6, 0.7, 0.8, 0.9, 1.0, 1.1, 1.2, 1.3, 1.4, 1.5, 1.6, 1.7, 1.8, 1.9, or 2.0 kgf or more. In some embodiments, the methods provide produce having a GC of at least about 0.3 kgf mm⁻¹, e.g. at least about 0.4, 0.5, 0.6, 0.7, or 0.8 kgf mm⁻¹.

The methods provided herein include vacuum impregnation (VI) of the produce in an infusion solution comprising firming agents. VI promotes compositional changes in produce that improves texture. During the VI process, porous tissues are submerged in a solution containing firming agents and subjected to a partial vacuum. Application of the vacuum results in extraction of air from intercellular spaces, while the restoration of atmospheric pressure (i.e. release of the vacuum) allows the impregnation of the solution into intercellular spaces. Mass transfer during VI is a hydrodynamic mechanism comprising capillary action and a pressure gradient, coupled with the deformation-relaxation phenomenon. VI may also be utilized to infuse bioactive constituents, including antioxidants, minerals, and probiotics. Exemplary firming agents include, but are not limited to, pectin (e.g. low methoxyl pectin or pectin methylesterase), starch, alginate, gelatin, or other hydrocolloids, and divalent cations such as calcium (e.g. via calcium chloride), magnesium, manganese, cobalt, zinc, and copper.

Pectin is a structural heteropolysaccharide contained in the primary cell walls of terrestrial plants. It is produced commercially as a white to light brown powder, and comprises a complex set of polysaccharides, including e.g. heterogalacturonans and substituted galacturonans. Isolated pectin has a molecular weight of typically 60,000-130,000 g/mol, varying with origin and extraction conditions. Pectin is readily isolatable from a variety of sources (e.g. citrus fruit) and is readily available from commercial sources.

Low Methoxyl Pectin (LMP) is extracted from the peels of citrus fruit. Pectin comprises a complex set of polysaccharides that are present in most primary cell walls of plants. The main use for pectin is as a gelling agent, thickening agent and stabilizer in food. The classical application is giving the jelly-like consistency to jams or marmalades, which would otherwise be sweet juices. Pectin can also be used to stabilize acidic protein drinks, such as drinking yogurt, and as a fat substitute in baked goods. LMP requires a lower amount of sugar to form a gel. LMP can form a gel in the presence of divalent cations, such as calcium while high methoxyl pectin (HMP) requires a larger amount of sugar to form a gel. The degree of esterification (DE) for LMP is <50%.

In some embodiments, the polysaccharide is present in the infusion solution at a concentration of 0.5-1.5% w/w, e.g. about 0.8-1.2% w/w, e.g. about 1.0% w/w. In some embodiments, the calcium chloride is present at a concentration of 0.020-0.040 mg per g of polysaccharide, e.g. 0.025-0.040 mg or about 0.035 mg per g of polysaccharide.

The microstructural properties of fruit and vegetable tissues may also play a role in VI. The highest concentration of pectin is found in the middle lamella, where calcium plays an important role in maintaining the cell-wall structure by forming a firm gel-like structure. Lowmethoxyl pectin (LMP) forms gel in the presence of calcium, which acts as a bridge between pairs of carboxyl groups of pectin molecules on adjacent polymer chains in close proximity VI treatment may increase hardness through crosslinking of pectin in the cell wall, which increases mechanical strength. VI treating food before freezing can reduce drip loss and improve the texture of frozen products.

VI conditions, including the level of vacuum, restoration times, type of solution, and solution temperature, can influence the efficacy of the solute infusion. In some embodiments, the vacuum level applied to the produce submerged in the infusion solution is at least about 40-60 kPa, e.g. at least about 45-55 kPa, e.g. at least about 50.8 kPa. The vacuum may be applied for 1-20 minutes, e.g. 5-15 minutes, e.g. about 7 minutes. In some embodiments, the restoration time is from 1-10 minutes, e.g. 3-7 minutes, e.g. about 5 minutes. In some embodiments, the infusion solution is an aqueous infusion solution. In some embodiments, the infusion solution is maintained at a temperature of 10-30° C., e.g. 15-25° C., e.g. about 20° C. In some embodiments, a ratio of produce to infusion solution is from 1:2 to 1:6 (w/w), e.g. about 1:4 (w/w).

After VI, the produce may be removed from the infusion solution and partially dried. For example, the produce may be air dried at a temperature of 55-70° C., e.g. about 60-68° C., e.g. about 65° C. at an air velocity of about 1-2 m/s, e.g. about 1.5 m/s or at least 1.3 m/s. The produce is dehydrated to reduce its water content below its original harvest-level of hydration, e.g. to a level of about 0.8 g of H₂O/g of fruit or less, e.g. about 0.7 g or 0.65 g of H₂O/g of fruit or less. In some embodiments, the produce is subjected to osmotic dehydration in which the water is partially removed from produce tissues by immersion in a hypertonic (osmotic) solution. In some embodiments, the produce is subjected to a combination of both air drying and osmotic dehydration.

In some embodiments, an edible coating is applied to the partially dried produce before freezing. The edible coating reduces moisture transfer and solute migration from the produce, whose mechanical strength has been improved using vacuum impregnation and partial drying. The edible coating can provide structural stability preventing mechanical damage during processing, reducing respiration rates, controlling water migration and reducing loss of components that stabilize organoleptic properties demanded by the consumers. The edible coating may comprise at least one of sodium alginate (e.g. TICA-algin® 400), sodium carboxymethylcellulose gums (e.g. Ticalose® CMC 2700 F NGMO), hydrocolloids (polysaccharides) such as starch, carrageenan, carboxymethylcellulose, gum Arabic, chitosan (e.g. Ticaloid® 911 powder), pectin, and xanthan gum, polypeptides (protein-based) such as collagens, gelatin, zein, casein, whey, soy and pea proteins, and lipids such as carnauba wax, candellila, Shellac, rosin, and beeswax.

In some embodiments, if sodium alginate is used, it is at a concentration of 0.1-1.0% w/v, e.g. about 0.2-0.6% w/v, e.g. about 0.4% w/v. In some embodiments, if sodium carboxymethylcellulose is used, it is at a concentration of 0.01-0.1% w/v, e.g. about 0.03-0.07% w/v, e.g. about 0.05% w/v. The edible coating solution may be an aqueous solution and comprise additional components such as glycerol and a surfactant. The edible coating may be applied using any method known in the art including spray or dip coating.

Examples of surfactants that may be used include, but are not limited to: cetyl trimethylammonium bromide CTAB); non-ionic surfactants such as RANIER EA®, the plant phenol lignin, polysorbate surfactants (or TWEEN® surfactants), e.g., polyoxyethylene (20) sorbitan monolaurate, also referred to as “TWEEN® 20,” or polyoxyethylene (80) sorbitan monolaurate, also referred to as “TWEEN® 80”; sorbitan surfactants (or SPAN® surfactants), e.g., sorbitan monolaurate, also referred to as “SPAN® 20,” or sorbitan monooleate, also referred to as “SPAN® 80”; and combinations thereof); etc. The amounts of the one or more surfactants is generally in the range of from about 0.01%-0.25% w/v, such as about from 0.1 to 0.2% w/v, e.g. about 0.15% w/v.

In some embodiments, the edible coating solution and/or the infusion solution contains one or more hydrophobic substances that can be blended with water to form suitable solvents which include but are not limited to: aliphatic acids and their derivatives (e.g. esters, salts, sulfonates), aliphatic alcohols and their derivatives (e.g. esters, ethers), aromatic alcohols and their derivatives (e.g. phenols, phenolic acids).

After the produce has been partially dried and the optional edible coating applied, the produce may then be preserved by freezing. In some embodiments, the produce is frozen using air blast freezing. Air blast freezing is the process of taking a product at a temperature (usually chilled but sometimes at ambient temperature) and freezing it rapidly, between 12 and 48 h, to its desired storage temperature, e.g. to about −15 to −50° C., e.g. about −30 to −40° C., e.g. about −35° C. In some embodiments, the item of produce is frozen to a temperature at or below −18° C. In some embodiments, the produce is cryogenically frozen, e.g. by applying liquid nitrogen or liquid helium to the produce until the desired core temperature is reached.

The methods described herein provide produce that is “baking stable” and in which syneresis is minimized. The term syneresis refers to the liquid oozing out of a large number of foods such as jams, jellies, sauces, dairy products, etc. In syneresis, the liquid exuded from the product occurs after the gel network is destroyed. This makes products less appealing to consumers. The higher the tendency for syneresis, the less baking stability a product possesses. The methods of the disclosure provide stability to fruit fillings during the baking process.

It is to be understood that this invention is not limited to particular embodiments described herein above and below, and as such may, of course, vary. It is also to be understood that the terminology used herein is for the purpose of describing particular embodiments only and is not intended to be limiting.

Where a range of values is provided, it is understood that each intervening value between the upper and lower limit of that range (to a tenth of the unit of the lower limit) is included in the range and encompassed within the invention, unless the context or description clearly dictates otherwise. In addition, smaller ranges between any two values in the range are encompassed, unless the context or description clearly indicates otherwise.

Unless defined otherwise, all technical and scientific terms used herein have the same meaning as commonly understood by one of ordinary skill in the art to which this invention belongs. Representative illustrative methods and materials are herein described; methods and materials similar or equivalent to those described herein can also be used in the practice or testing of the present invention.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual dates of public availability and may need to be independently confirmed.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as support for the recitation in the claims of such exclusive terminology as “solely,” “only” and the like in connection with the recitation of claim elements, or use of a “negative” limitations, such as “wherein [a particular feature or element] is absent”, or “except for [a particular feature or element]”, or “wherein [a particular feature or element] is not present (included, etc.) . . . ”.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

### EXAMPLES

### Example 1. Developing Vacuum-Impregnated Dehydrofrozen Red Raspberries with Improved Mechanical Properties

### Summary

The incorporation of red raspberries in bakery and dairy products is limited due to the fragility of the berries. This compromises the appearance of the food product due to the bleeding of juice caused by tissue rupture. In this study, we developed vacuum-impregnated dehydrofrozen red raspberries from fresh fruit. Initially, we optimized drying and freezing conditions for red raspberries that were not vacuum impregnated using air drying alone and in combination with osmotic dehydration, followed by air blasting and cryogenic freezing methods. Later, optimal conditions of partial drying and freezing were used for raspberries that were vacuum impregnated with low methoxyl pectin (LMP) at 10 g of pectin kg⁻¹ of solution and calcium chloride (CaCl₂2H₂O) at 30 g of calcium kg⁻¹ of pectin. The berries were partially dehydrated using hot air (65° C.) until a final water content of 0.65 g of water g⁻¹ of fruit was reached. Next, the berries were placed in glass jars, sealed, and cooled at 4° C. for 2 h. They were then frozen by air blasting and stored for 2 months at −35° C. prior to evaluation. The mechanical properties of the berries, including the maximum force (FM) and gradient (GC), were considered to be suitable indicators of fruit firmness. Results demonstrate that raspberries impregnated with pectin and calcium and then partially dried and frozen have higher FM and GC values than commercially frozen thawed berries. These dehydrofrozen raspberries show improved structural integrity for use in bakery and dairy products.

### Materials and Methods

### Raw Materials

Fresh red raspberries (Rubus idaeus L. cv. Meeker) were purchased from local grocery stores in Pullman, Wash., USA. The fresh fruit was stored at 4° C. and processed within three days of purchase. Raspberries were prescreened visually. Uniformly sized whole berries of similar firmness (to touch) and free of physical and fungal damage were selected. Frozen berries (Great Value Whole Red Raspberries, Walmart Stores, Inc., Bentonville, Ark., USA) were labeled as commercially frozen. Deionized water (DI) was used to prepare the processing solutions. All chemicals were of analytical grade: calcium chloride dihydrate (VWR International, LLC, Batavia, Ill., USA); Grade II sucrose (Sigma-Aldrich, Milwaukee, Wis., USA); LMP (TIC PretestedVR Pectin LM 35 powder) donated by TIC gums, White Marsh, Md., USA.

### Process Description

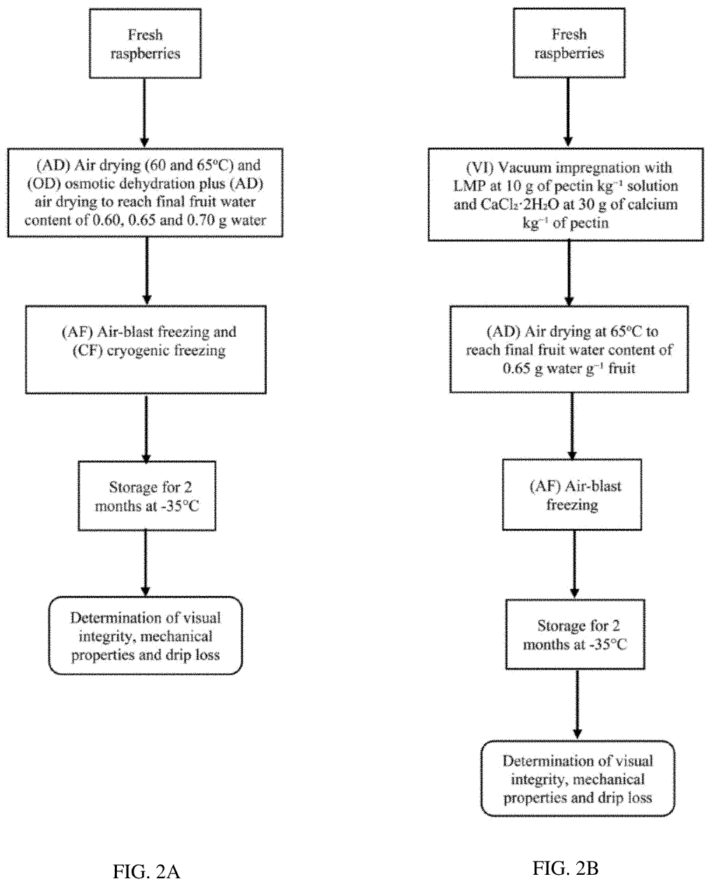

The development of vacuum-impregnated dehydrofrozen berries was performed in two stages. In the first stage, we optimized conditions for dehydrofreezing treatments with non-vacuum-impregnated red raspberries. Fresh berries were subjected to partial drying. Two drying methods were performed air drying alone and a combination of osmotic dehydration (OD) and air drying (AD). Dried berries were then frozen by either cryogenic (CF) or air-blast freezing (AF) (FIG. 2a). We evaluated visual integrity, mechanical properties, and drip loss in order to optimize the drying and freezing conditions.

In the second stage, red raspberries were first subjected to a vacuum impregnation (VI) pretreatment. The optimal conditions of VI were based on our previous research. [14] The conditions were: low methoxyl pectin (LMP) at 10 g of pectin kg⁻¹ of solution and calcium chloride (CaCl₂ 2H₂O) at 30 g of calcium kg⁻¹ of pectin in DI water, vacuum level 50.8 kPa, 7 min vacuum time, 5 min restoration, and solution temperature of 20° C. Vacuum-impregnated pretreated berries were then subjected to optimal conditions of partial drying and freezing as determined in the first stage for non-vacuum impregnated berries. Frozen berries inside the closed jars were stored in an air-blast freezer at −35° C. for 2 months. The mechanical properties, visual integrity, and drip loss of treated raspberries were analyzed (FIG. 2b).

### Dehydration

Two methods of partial drying were performed for fresh raspberries: air drying (AD) alone and osmotic dehydration followed by air drying (OD [symbol] AD). Approximately 100 g of fruit were used for each treatment. The water content of fresh raspberries was determined using an oven method (Model ED-53L Binder GmbH Tuttligen, Germany) at 105±2° C. over 24 h to achieve a constant weight. This procedure was performed 3 times.

### Air Drying

Air drying was performed in a hot air-circulated drier (Armfield, UOP8, Hampshire, England). Air velocity was measured with an anemometer (Extech AN 300, Nashua, N.H., USA). Raspberries were placed on sample trays inside the air drier. The weight of the samples and the trays was measured. The drying time and dry bulb temperature of the air were also recorded. The wet bulb temperature was measured with an external psychrometer. Two dry bulb temperatures were used: 60 and 65° C. and the air velocity was 1.5 m s⁻¹. The raspberries were dried until the water content reached 0.70, 0.65, and 0.60 g of water g⁻¹ of fruit. The fruit was then carefully placed into glass jars, and the jars were sealed and cooled at 4° C. for 2 h prior to freezing.

### Osmotic Dehydration and Air Drying

Fresh raspberries were placed in a glass container containing a hypertonic solution. The hypertonic solutions were prepared by dissolving sucrose to DI until it reached a 60° Brix sirup. The temperature of the solution together with fruit was maintained at 30° C. by placing the beaker in a water bath. In order to reach approximately 16° Brix, osmotic dehydration was performed by completely immersing the raspberries in a sucrose sirup at a fruit-to-sirup ratio of 1:5 (w/w). Preliminary research was carried out to determine the time needed to reach at least 16° Brix. These experiments were conducted at different temperatures: 25, 30, and 40° C. The results were evaluated, and times were recorded. The berries were then subjected to osmotic dehydration at optimal solution temperature of 30° C. The fruit was then air dried by following the air-drying procedure previously described, at dry bulb temperatures of 60 and 65° C. and an air speed of 1.5 m s⁻¹, until the water contents of 0.70, 0.65, and 0.60 g of water g⁻¹ of fruit were reached. A total soluble solids analysis of fruit was performed before and after processing. The fruit was then carefully placed in glass jars. The jars were sealed and cooled at 4° C. for 2 h before cryogenic or air-blast freezing.

### Freezing

To determine the effect of air-blast freezing (AF) and cryogenic freezing (CF) on raspberries, the following procedures were performed. For AF, dried raspberries in closed glass jars were directly transferred to an air freezer at −35° C. for 2 months storage until the analysis was conducted. For CF, partially dried fruit was placed on a stainless-steel wired tray and manually sprayed with liquid nitrogen (U.S. Solid, Ohio, USA) for approximately 2 min until their core temperature reached −25° C. To determine the temperature inside the berries, two thermocouples (Fluke 80PK-1 probe beaded K-Type range −40 to 260° C., Fluke Corporation, Everett, Wash., USA) were used. Exposed probes were carefully inserted into randomly selected berries. Thermocouples were connected to a thermometer (Fluke 5211 Dual Input Digital thermometer, Fluke Corporation, Everett, Wash., USA). After reaching the target temperature, the cryogenically treated berries were placed into glass jars. The jars were closed and transferred to a blast freezer at −35° C. for 2 months of storage until the drip loss and texture analyses were conducted.

### Mechanical Properties, Drip Loss, and Soluble Solids (° Brix) Analysis

The mechanical properties of the berries were determined using a texture analyzer (Model TA-XT2, Stable Micro Systems, Godalming, England) with a 25 kg load cell. The texture analyzer was fitted with a 50 mm diameter aluminum probe, operated at a constant speed of 0.5 mm s⁻¹. The longest axis of each berry was placed parallel to the base plate. The samples were compressed until there was an 80% strain. Raspberry firmness was evaluated through the determination of maximum force (FM) and gradient (GC). FM corresponds to the maximum force obtained during texture analysis, while GC corresponds to the last slope in a curve force-distance before maximum force was recorded. [26] Ten berries were analyzed per experiment, and each experiment was performed three times.

### Drip Loss Analysis

Two drip loss assessment methods were evaluated. In the first method, frozen berries were laid on absorbent paper and thawed at 24° C. for 6 h. The drip loss of the frozen raspberries was determined by recording the weight before and after thawing. However, the obtained results under this procedure were not consistent across different sets of berries.

A second method resulted in more consistent results. In this method, frozen berries were thawed inside sealed glass containers, for 6 h at 24° C. After thawing, the berries were removed from the jars, and the jars were weighted again to determine the amount of liquid. The drip loss of frozen raspberries was determined by recording the weight change before and after thawing.

### Total Solids (Brix) Analysis

The percentage of soluble solids in the fruit was determined before and after drying, as well as after freezing. The raspberries were chosen randomly and placed in a 50 ml glass beaker. The raspberries were homogenized at 5200 RPM for 2 min in a homogenizer (Model Kinematica Politron pt-2500 E, Bohemia, N.Y., USA) at 24° C. The percentage of soluble solids in the puree was measured using a hand-held digital pocket refractometer (Model Atago pal-a 0-85%, Itabashi-Ku, Tokyo, Japan). This procedure was performed three times.

### Preparation of Solutions

Vacuum impregnation solutions were prepared using Pectin LM 35 powder at a concentration of 10 g of pectin kg⁻¹ of solution and 30 g of calcium kg⁻¹ of pectin, in DI water at 20° C. [14] The pH of the solution was adjusted with granulated citric acid to between 3.2 and 3.6. All hypertonic solutions for OD were prepared by adding sucrose to DI water at 20° C. until they reached a 60° Brix sirup.

### Vacuum Impregnation of Berries

The VI conditions used in this study were selected based on our previous study. [14] Fresh raspberries were placed in a glass container containing the impregnation solution. To ensure that the fruit remained submerged in the solution during treatment, a plastic mesh was cut to tightly fit the container and placed below the level of liquid. In each experiment, a ratio of 1:4 (w/w) fruit to impregnation solution, was maintained. The VI pretreatment was conducted by using impregnation solutions with LMP-calcium at 20° C. and a vacuum level of 50.8 kPa, for 7 min in a vacuum chamber (Model No. 1410-2 Sheldom Manufacturing, Cornelius, Oreg., USA) connected to a vacuum pump (Edwards 12 Two stage, oil sealed rotary vane, Hillsboro, Oreg., USA). Once the vacuum stage was completed, the chamber was allowed to return to atmospheric pressure, and the raspberries remained in the impregnation solution for 5 min. Liquid was drained off the berries by holding them in a stainless-steel colander. Each berry was carefully dried with tissue and swabs to remove the excess solution from the surface, and then subjected to partial dehydration and air-blast freezing (FIG. 2b). This process was performed on three sets of raspberries.

### Statistical Analysis

Analysis of data was performed using SAS 9.2. A completely randomized factorial design with three replicates was used. Each replicate involved 10 raspberries. An analysis of variance, ANOVA, and Fisher's Least Significant Difference, LSD, test at level of significance of p≤0.05 were used to establish the difference between mean values for drying and freezing methods. Multiple comparisons between measured variables were performed among the set of population means.

### Results and Discussion

### Partial Removal of Water

An initial study was performed with non-vacuum impregnated berries to determine optimal conditions for partial removal of water using both air drying and a combination of osmotic dehydration and air drying. Preliminary experiments conducted with air drying of raspberries at 50° C. resulted in a drying time of over 20 h to reach a water content level of 0.70 g of water g⁻¹ of fruit. Such a drying time is impractical in the food industry and therefore this temperature was not considered for further studies. Similarly, in the preliminary study, the effect of air velocities was also tested at different temperatures. The best air velocity to minimize drying time was 1.5 ms⁻¹. Hence, the air velocity of 1.0 ms⁻¹ was not considered for further experiments.

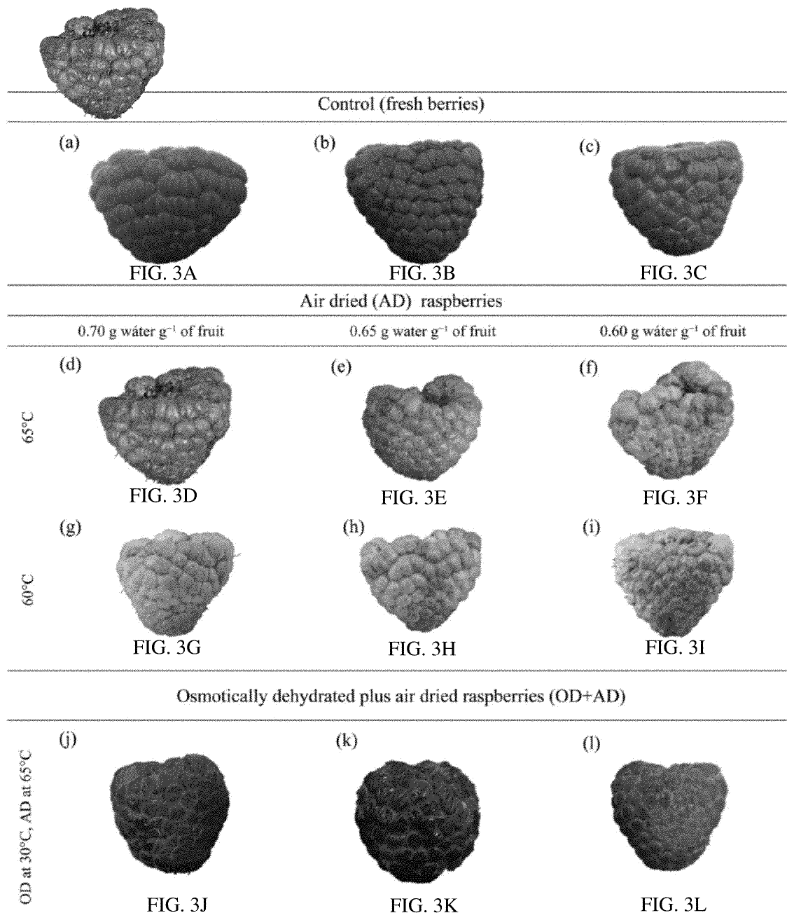

Red raspberries dried at 65 and 60° C. to reach a water content of 0.60 g of water g⁻¹ of fruit showed degradation of color and physical damage due to the long drying times of 11.5 and 15 h, respectively. Furthermore, raspberries dried at these conditions showed drupelet damage (FIG. 3). Raspberries dried at 65° C. to a water content of 0.65 g of water g⁻¹ of fruit resulted in better visual integrity and color than at 60° C. due to reduced drying time. In general, all dehydration processes showed changes in fruit color and texture. Previous studies on raspberry pulp indicate that increasing the heating treatment to a range of 60-90° C. degrades the color. [27]

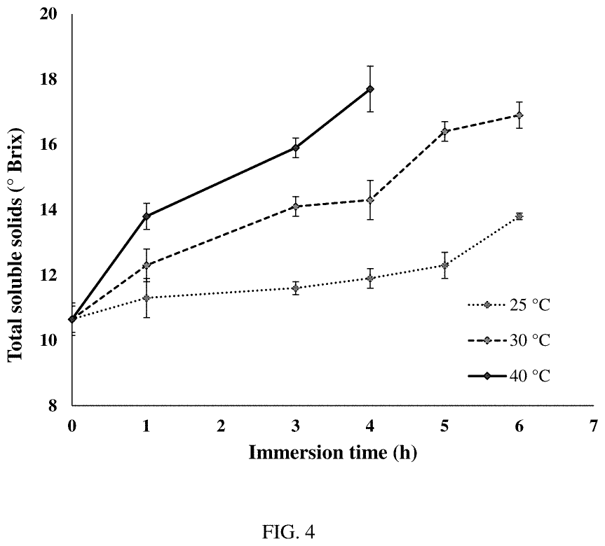

Results of osmotic dehydration indicate that increasing the solution temperature from 25 to 40° C. increases the rate of water loss from berries. This is shown in FIG. 4 by the higher total soluble solids content during dehydration. However, a higher solution temperature of 40° C. resulted in very fragile berries that were difficult to handle. Hence, a solution temperature of 30° C. and a 5 h immersion time to reach 16° Brix (approximately, 0.7 g of water g⁻¹ of fruit) was selected for further experiments.

The OD berries were then air dried at 65° C. and air velocity of 1.5 m s⁻¹ until they reached 26 and 30 Brix (corresponding water contents of 0.65 and 0.60 g of water g⁻¹ of fruit, respectively) (Table 1). Although the combination of OD [symbol] AD did not result in significant color changes in the raspberries, the treated berries were soft, sticky, and difficult to handle. In addition, a total dehydration time greater than 13 h was required to achieve the desired final water content. The combination treatment of OD [symbol] AD did not result in significant improvement compared to air drying alone. Similar results were reported in osmotic dehydration followed by air drying of raspberries. [9] Degradation of polysaccharides and removal of pectin from the tissue structure during OD can occur and soften the fruit. Furthermore, the peak force and maximum slope used to characterize the mechanical properties of raspberries after combined use of OD and AD showed a significant reduction compared to that of control samples.

TABLE 1
Drying time and water content of raspberries dehydrated through
hot air at different temperatures. Air velocity 1.5 m s⁻¹.

| Temperature | Water content | TSS¹ | Drying time |
|---|---|---|---|
| (° C.) | (g water g⁻¹ fruit) | (°Brix) | (h) |
| 65 | 0.70 | 16.43 | 7.5 |
| | 0.65 | 26.18 | 9.3 |
| | 0.60 | 30.08 | 11.5 |
| 60 | 0.70 | 19.24 | 11.0 |
| | 0.65 | 22.62 | 13.6 |
| | 0.60 | 33.51 | 15.0 |

¹TSS total soluble solids

Xu et al. [8] studied the ultrasound-assisted osmodehydrofreezing technique to accelerate mass transfer during the osmotic dehydration stage to preserve the quality of radish cylinders. Firmness and drip loss were evaluated as indicators of quality. Ultrasound-assisted osmotic dehydrated radishes exhibited higher firmness than either osmotic dehydrated or control samples. This may be attributed to ultrasound waves that can develop a rapid series of compression and expansion cycles. This, in turn, induces the formation of microscopic channels inside the solid, increasing the mass transfer of solute. In addition, the drip loss after thawing of ultrasound-assisted osmodehydrofrozen product was lower than the only osmotic dehydrated and control samples. This may be due to the higher content of sugar, which has a higher capacity to hold water, within the ultrasound-assisted dehydrated products.

### Dehydrofrozen Berries

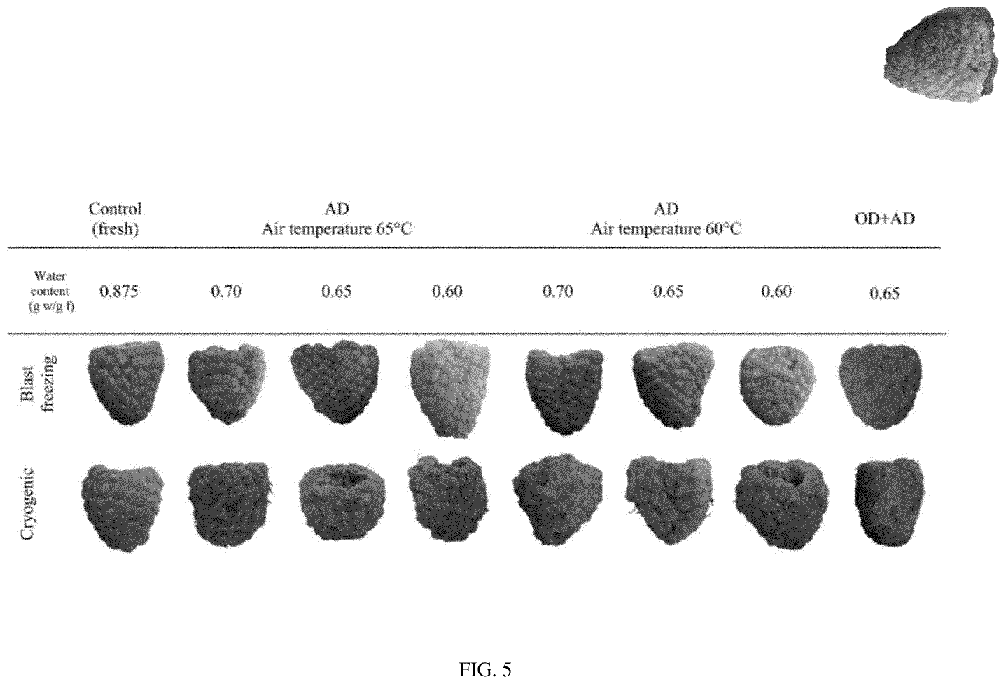

In this study, AF resulted in a better visual integrity of red raspberries than did CF. Evident damage was noticed on the drupelets of air-dried berries frozen cryogenically compared to those frozen in an air-blast freezer (FIG. 5). This effect was also observed while liquid nitrogen was sprayed on the surface of the fruit. Although CF is associated improved quality in food products, studies show that it can also create fractures on berry skin due to thermal shock. [28] Overall, berries that were dried at 65° C. to a water content between 0.65 and 0.70 g of water g⁻¹ of fruit suffered minimal damage. However, berries that were dried using a combination of OD [symbol] AD showed shrinkage. With combined OD [symbol] AD, the internal stress generated at the microstructural level may have resulted in a cracked and porous product. Sette et al. [29] also reported shrinkage of 27-46% in berries subjected to different conditions of osmotic dehydration after a reduction in moisture content from 85% to 51% (w/w).

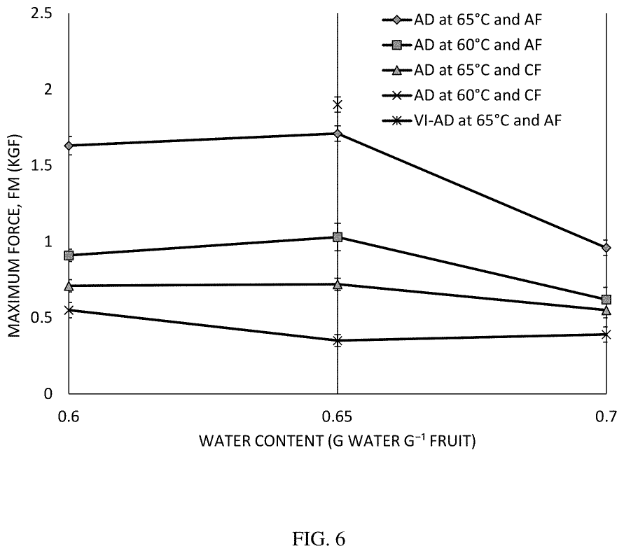

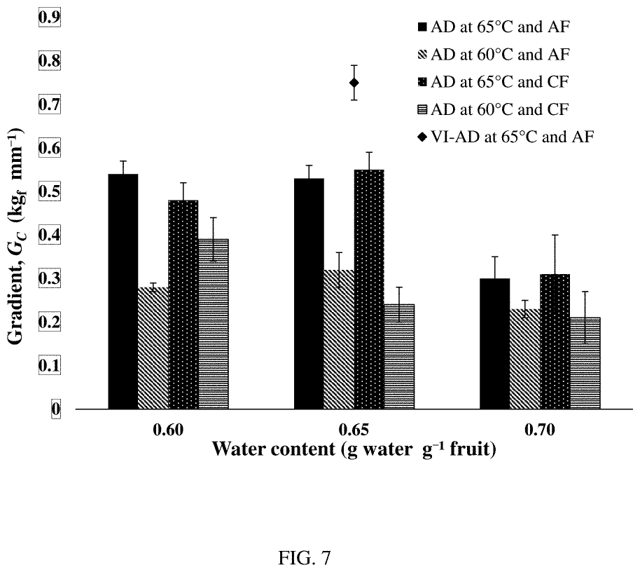

CF and AF treatments of the control berries did not create noticeable differences in visual quality of samples. Raspberries that were air dried and then frozen in an air-blast freezer and then thawed had higher FM values than those that were air dried and then frozen using CF (FIG. 6). In general, berries that were dried and frozen at 65° C. showed higher FM values, than berries that were dried and frozen at 60° C. for, both freezing techniques at the same temperature and water content. When raspberries were dried from 0.7 to 0.65 g of water g⁻¹ of fruit and then frozen with air-blast or cryogenic freezing, FM increased. Overall, raspberries dried at 65° C. to water contents of 0.60 and 0.65 g of water g⁻¹ of fruit and frozen in an airblast freezer showed the highest FM values (1.63 kgf and 1.71 kgf), respectively. Higher air-drying temperature resulted in higher firmness due to the reduced drying time needed to achieve of the same final moisture content. Lower air temperature and higher drying time were more damaging to the microstructure of berries than a higher air temperature and shorter drying time. Similarly, CF effect on fruit texture more severe compared to AF resulting in less firm berries after thawing. The GC values of dehydrofrozen berries by using AF (0.54 kgf mm⁻¹) followed similar trends in terms of the effect of the drying temperature and final water content (FIG. 7). However, GC values for berries air dried at 65° C. to a water content of 0.60 and 0.65 g of water g⁻¹ of fruit and frozen using the CF method did not differ significantly from that of air-blast frozen berries.

Results from this study differ from those of other studies on apples in terms of the benefits of fast freezing over slow freezing using the CF method. [30] The combination of OD p AD in berries at both the AF and CF freezing rates showed no significant difference (p≤0.05) in the FM (0.57 and 0.49 kgf) and GC (0.19 and 0.22 kgf mm⁻¹), respectively (Table 2). When the fruit was immersed in the impregnation solution for an extended time following air drying, the berries became softer than those that were only air dried. Since the berries were already soft after OD [symbol] AD, the freezing methods CF and AF did not significantly influence (p≤0.05) the FM and GC of berries. Commercially frozen raspberries had the lowest GC value (0.10 kgf mm⁻¹), probably due to greater damage to cellular structure after thawing. The AF and CF control berries (frozen in our laboratory without partial dehydration) also showed lower GC values (0.21 and 0.16 kgf mm⁻¹) than the GC values of dehydrofrozen berries at 65° C. and 0.65 and 0.6 g of water g⁻¹ of fruit at AF (0.54 kgf mm⁻¹). Studies show that partial dehydration as a pretreatment in cut quince fruit reduced the negative impacts of freezing on the textural properties of the fruit. [7] Overall, dehydrofrozen products showed better quality than commercially frozen products with original moisture content.

TABLE 2
Physicochemical properties of raspberries after thawing at different conditions

| | Drying | Water content | | | | Mechanical properties | |
|---|---|---|---|---|---|---|---|
| | temperature | (g water | Freezing | TSS³ | Drip loss | G_{C} | F_{M} |
| Treatment¹ | (° C.) | g⁻¹ fruit) | rate² | (° Brix) | (%) | (kg_{f} mm⁻¹) | (kg_{f}) |
| Control | — | 0.87 | AF | 9.06 ± 0.06^{j} | 4.27 ± 0.35^{de} | 0.21 ± 0.04^{hi} | 0.76 ± 0.03^{f} |
| AD | 65 | 0.70 | AF | 23.35 ± 0.77^{fg} | 1.57 ± 0.12^{g} | 0.30 ± 0.05^{fgh} | 0.96 ± 0.05^{de} |
| AD | 65 | 0.65 | AF | 26.25 ± 0.32^{c} | 1.45 ± 0.07^{g} | 0.53 ± 0.03^{cd} | 1.71 ± 0.05^{b} |
| AD | 65 | 0.60 | AF | 29.05 ± 1.78^{b} | 1.68 ± 0.44^{g} | 0.54 ± 0.03^{cd} | 1.63 ± 0.06^{b} |
| AD | 60 | 0.70 | AF | 19.62 ± 1.43^{h} | 2.47 ± 0.46^{fg} | 0.23 ± 0.02^{hi} | 0.62 ± 0.08^{f} |
| AD | 60 | 0.65 | AF | 24.54 ± 0.39^{ef} | 1.77 ± 0.47^{g} | 0.32 ± 0.04^{f} | 1.03 ± 0.09^{d} |
| AD | 60 | 0.60 | AF | 25.56 ± 0.65^{de} | 1.77 ± 0.15^{g} | 0.28 ± 0.01^{fghi} | 0.91 ± 0.04^{e} |
| OD + AD | — | 0.65 | AF | 22.75 ± 0.52^{g} | 6.53 ± 1.21^{c} | 0.19 ± 0.06ⁱ | 0.57 ± 0.04^{g} |
| Control | — | 0.87 | CF | 9.80 ± 0.31^{j} | 3.73 ± 1.37^{e} | 0.16 ± 0.01ⁱ | 0.55 ± 0.03^{g} |
| AD | 65 | 0.70 | CF | 23.04 ± 0.25^{fg} | 2.40 ± 0.44^{f} | 0.31 ± 0.09^{f} | 0.55 ± 0.05^{g} |
| AD | 65 | 0.65 | CF | 26.15 ± 0.58^{cd} | 3.18 ± 1.16^{ef} | 0.55 ± 0.04^{c} | 0.72 ± 0.04^{f} |
| AD | 65 | 0.60 | CF | 34.70 ± 1.21^{a} | 3.93 ± 0.84^{de} | 0.48 ± 0.04^{d} | 0.71 ± 0.04^{f} |
| AD | 60 | 0.70 | CF | 20.88 ± 0.55^{h} | 4.93 ± 1.23^{d} | 0.21 ± 0.06ⁱ | 0.39 ± 0.05ⁱ |
| AD | 60 | 0.65 | CF | 23.75 ± 0.35^{fg} | 4.10 ± 0.36^{de} | 0.24 ± 0.04^{gi} | 0.35 ± 0.04ⁱ |
| AD | 60 | 0.60 | CF | 29.58 ± 0.50^{b} | 3.51 ± 0.42^{ef} | 0.39 ± 0.05^{e} | 0.55 ± 0.05^{g} |
| OD + AD | — | 0.65 | CF | 27.48 ± 0.69^{c} | 8.64 ± 0.69^{bc} | 0.22 ± 0.08^{hi} | 0.49 ± 0.01^{gh} |
| VI + AD | 65 | 0.65 | AF | 30.12 ± 1.23^{b} | 1.11 ± 0.32^{h} | 0.75 ± 0.04^{a} | 1.9 ± 0.05^{a} |
| VI | — | 0.87 | AF | 29.97 ± 0.76^{b} | 1.00 ± 0.09^{h} | 0.67 ± 0.03^{b} | 1.54 ± 0.06^{c} |
| CFR⁴ | — | 0.87 | — | 13.72 ± 0.75ⁱ | 16.80 ± 0.20^{a} | 0.10 ± 0.02^{j} | 0.42 ± 0.02^{hi} |

*Values within each column followed by a different letter are significantly different (p <0.05). Results reported are mean ± SD.
¹AD Air drying; VI + AD vacuum impregnation and air drying; OD + AD osmotic dehydration plus air drying.
²AF Air blast freezing; CF Cryogenic freezing.
³TSS total soluble solids.
⁴CFR Commercially frozen raspberries.

The drip loss from berries frozen with liquid nitrogen was significantly (p≤0.05) higher than that of airblast frozen berries. The faster rate of freezing with liquid nitrogen affected the berry skin. This may have weakened the fruit structure, allowing loss of liquid upon thawing. The air-drying temperature and final water content of berries under the same freezing treatment did not significantly (p≤0.05) affect drip loss.

The drip loss in partially AD berries at 65° C. followed by AF was significantly (p≤0.05) lower (1.5%) compared to that of commercially frozen berries (16.8%), control berries AF and CF (4.27% and 3.73%) and OD [symbol] AD berries at AF and CF (6.53% and 8.64%). The commercial samples showed the highest drip loss within all treatments carried out in this study (Table 2). The commercially frozen berries may have undergone several temperature cycles during transportation and storage, resulting in ice recrystallization and damage to the cellular structure of fruit. The ripeness of commercial frozen and control raspberries may also differ from each other. Sapers et al. [31] also reported a lower drip loss on slightly unripe berries after freezing and thawing.

### Dehydrofreezing of Vacuum-Impregnated Berries

Compared to fresh raspberries without any treatment, vacuum-impregnated berries did not show a difference in fruit color or visual quality. Air drying of vacuum-impregnated fruit was conducted at a 65° C. air temperature until berries reached to a water content level of 0.65 g of water g⁻¹ of fruit. Partial drying of berries at these conditions (65° C. air temperature and 0.65 g of water g⁻¹ of fruit) did not result in a change in color of the vacuum-impregnated berries. A 9.1 h drying time was required to achieve a water content of 0.65 g of water g⁻¹ of fruit in vacuum-impregnated dried raspberries. Air freezing of vacuum-impregnated and partially dried berries resulted in an acceptable visual quality. Since the overall effect of air freezing was better than cryogenic freezing in terms of mechanical properties, no further experiments were conducted using cryogenic freezing.

As expected, the vacuum-impregnated raspberries with LMP and calcium that were only air-blast frozen resulted in firmer fruit than fresh berries without treatment. This is likely due to binding of LMP and calcium to the cell wall, promoting crosslinking between ions and pectin in the middle lamella, which increases cell wall rigidity and fruit firmness. The FM (1.54 kgf) and GC (0.67 kgf mm⁻¹) values were significantly (p≤0.05) higher than the FM and GC values of fresh raspberries (0.26 kgf and 0.12 kgf mm⁻¹). On the other hand, drip loss in the vacuum-impregnated berries (1.0%) was significantly lower than that of fresh berries (3.9%) (Table 3). The mechanical properties (FM ¼ 1.9 kgf and GC ¼ 0.75 kgf mm⁻¹ values) of LMP and calcium-impregnated dehydrofrozen berries were higher than the FM and GC values of any other treatment (FIGS. 6 and 7). This indicates the benefits of VI dehydrofrozen treatment. The drip loss in vacuum-impregnated dehydrofrozen berries (1.1%) was significantly (p≤0.05) lower than the drip loss in any other treatment. The vacuum impregnation of firming agents before dehydrofreezing resulted in improved visual integrity and mechanical properties of red raspberries.

TABLE 3
Physicochemical properties of fresh and vacuum impregnated air blast frozen raspberries

| | Water content | | | Mechanical properties | |
|---|---|---|---|---|---|
| | (g water g⁻¹ | TSS¹ | Drip loss | G_{C} | F_{M} |
| Conditions | fruit) | (°Brix) | (%) | (kg_{f} mm⁻¹) | (kg_{f}) |
| Fresh | 0.87 | 10.65^{a} | 3.89 ± 0.34^{b} | 0.12 ± 0.11^{b} | 0.26 ± 0.23^{b} |
| AF Vacuum | 0.87 | 11.33^{a} | 1.00 ± 0.09^{a} | 0.67 ± 0.03^{a} | 1.54 ± 0.06^{a} |
| impregnated | | | | | |

*Values within each column followed by a different letter are significantly different (p ≤ 0.05). Results reported are mean ± SD

### Conclusions

This study demonstrated the development of vacuum-impregnated dehydrofrozen raspberries with improved mechanical properties and visual integrity. This development is important for expanding the utilization of raspberries in different products. The optimal treatment conditions included impregnation of red raspberries with LMP and calcium, drying at an air temperature of 65° C. to a water content level of 0.65 g of water g⁻¹ of fruit, and freezing in an airblast freezer at −35° C. The dehydrofrozen raspberries impregnated with firming agents showed significant improvement in firmness and visual integrity compared to untreated frozen berries.

### Example 2. Application of Vacuum Impregnation, Edible Coating and Dehydrofreezing to Minimize Syneresis in Red Raspberries During Baking

### Summary

In this study, we developed baking-stable red raspberries to minimize syneresis during baking. We applied three treatments to the red raspberries: vacuum impregnation with low methoxyl pectin (LMP) and calcium chloride at 20° C. and a vacuum level of 50.8 kPa, for 7 minutes; partial dehydration using hot air at a dry bulb temperature of 65° C. until the final water content of 0.65 g H₂O/g fruit was reached; and edible coatings at different concentrations. Treated berries were stored in a freezer at −35° C. for two months. We determined the mechanical properties, drip loss and visual integrity of the frozen-thawed red raspberries before baking to select appropriate coatings. Raspberry muffins were then baked to 204° C. for 20 minutes. We determined the syneresis from the baked fruit using image analyzer software ImageJ 1.46r. Findings indicate that sodium alginate at 0.4% (w/v), resulted in minimal bleeding at 13.9%, while commercial frozen raspberries showed bleeding at 62.9%.

### Materials and Methods

### Raw Materials

Fresh red raspberries (Rubus idaeus) were purchased from a local grocery store in Pullman, Wash. Upon arrival, the undamaged raspberries were screened visually. Uniformly sized raspberries were chosen. The fresh fruit was stored at 4° C. and kept under refrigeration no more than three days until the experiments were carried out. Frozen raspberries (Great Value Whole Red Raspberries, Walmart Stores, Inc., Bentonville, Ark. 72716), were used as a reference to determine syneresis after baking. Deionized water (DI) was used to prepare all process solutions. All chemicals were of analytical grades; glycerol anhydrous and acetic acid glacial (J. T. Baker, Avantor Materials, Phillipsburg, N.J.); Tween 20 (Sigma-Aldrich, Inc., St. Louis, Mo.); calcium chloride dihydrate (VWR International, LLC, Batavia, Ill.); Chitosan (Spectrum Chemicals and Laboratory Products, Gardena, Calif.); Ticalose® CMC 2700 F NGMO cellulose gum; Ticaloid® 911 cellulose gum powder; TICA-algin® 400 sodium alginate; and TIC Pretested® Pectin LM 35 powder. The last four chemicals were gifts from TIC GUMS, White Marsh, Md.

### Process Description

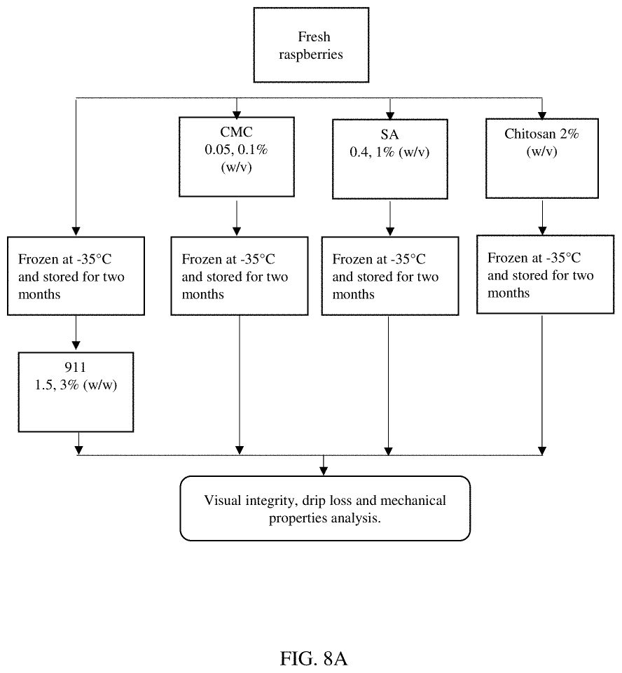

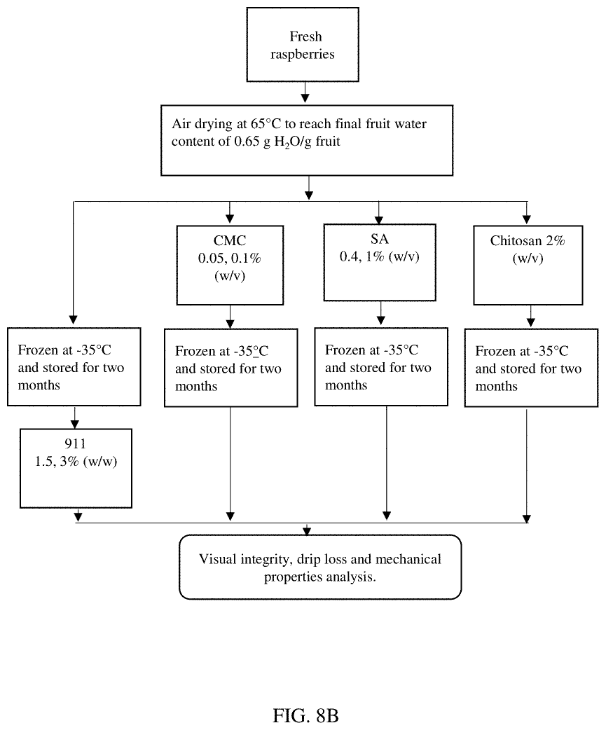

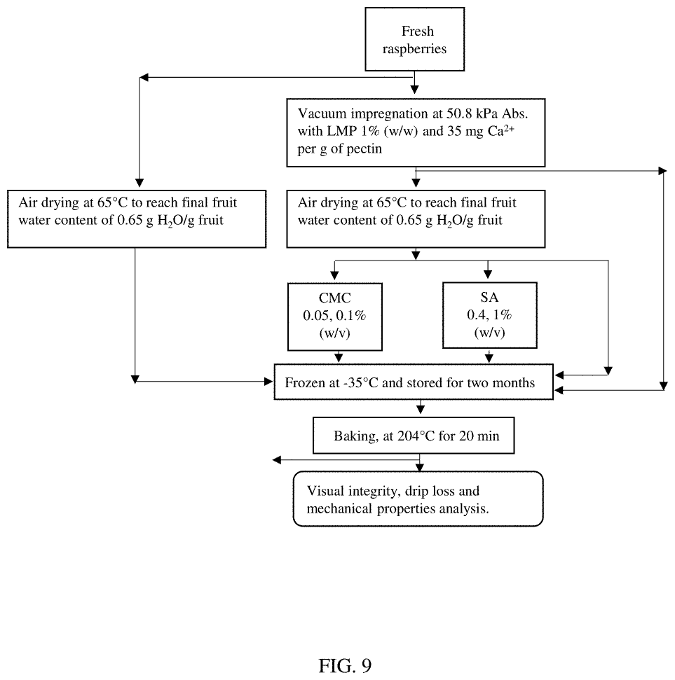

This experimental study was divided into two stages. In the first stage, performance of edible coatings was evaluated using only coated and partially dehydrated and coated berries (FIGS. 8a and b). The effect of different coatings and solution concentrations on the mechanical properties, drip loss and visual integrity of thawed raspberries was evaluated. Frozen and thawed berries without treatment were used as a control. Suitable edible coatings then were identified. In the second stage, fresh berries were subjected to vacuum impregnation before partial dehydration. The selected coatings were applied to pretreated berries before freezing at −35° C. The berries were stored frozen for two months and then incorporated in muffins. The degree of syneresis in the resulting muffins was evaluated. Furthermore, the mechanical properties, visual integrity and drip loss of berries were determined. Commercial frozen berries were also used in muffin baking for comparison.

### Treatments

### Vacuum Impregnation

An infusion solution containing LMP at 1% (w/w); calcium chloride (CaCl₂.2H₂O) at 35 mg of calcium per g of pectin, in DI water at 20° C. was prepared. Fresh raspberries were placed in a container of the solution. A ratio 1:4 (w/w) fruit to impregnation solution was maintained. A vacuum level of 50.8 kPa, for 7 min followed by 5 more min of restoration time was used to conduct the VI treatment. The experiment was performed by using a vacuum chamber (Model No. 1410-2 Sheldom Manufacturing, Cornelius, Oreg.) connected to a vacuum pump (Edwards 12 Two stages, oil sealed rotary vane, Hillsboro, Oreg.). Once the raspberries were infused, they were separated from the solution using a stainless-steel strainer. Each berry was individually dried with paper tissue and swabs and then kept at room temperature (24° C.) for 1 hour before further processing. Each experiment was performed three times.

### Air Drying

The water content of fresh raspberries was previously determined using an oven (Model ED-53L Binder GmbH Tuttligen, Germany) at 105±2° C., over 24 h to achieve a constant weight. This procedure was performed 3 times. Raspberries were air dried in an air-circulated drier (Armfield, UOP8, Hampshire, England) at 65° C. dry air temperature at air velocity of 1.5 m/s. The raspberries were dried until the water content reached 0.65 g H₂O/g fruit. The air velocity was measured with an anemometer (Extech AN 300, Nashua, N.H., USA). The raspberries were placed on sample trays inside the air drier. The samples trays were suspended from a scale connected to a computer, where the weight of the product, and the dry bulb temperature were monitored. Once the berries were dried, they were ready to be coated or frozen.

### Edible Coatings

Four hydrophilic edible coatings at different concentrations were selected for this experiment. Two sodium alginate TICA-algin® 400 (SA), two sodium carboxymethylcellulose gums Ticalose® CMC 2700 F NGMO (CMC), one Chitosan-based edible coatings, and two Ticaloid® 911 powder (911) were tested. The coatings were chosen based on available information on their use as stabilizers in baking fillings, as inhibitors of moisture transfer, or as stabilizers during heating.

The edible coating solutions were prepared as follows: two SA coating solutions were prepared by adding 0.4% and 1.0% of SA (w/v) in DI to 25% glycerol (w/SA dry weight) and 0.15% Tween 20 (w/v). These solutions were labeled in accordance to their level of concentration as SA L and SA H: two CMC coating solutions were prepared by adding 0.05% and 0.1% of CMC (w/v) in DI to 25% glycerol (w/CMC dry weight) and 0.15% Tween 20 (w/v). These solutions were labeled in accordance to their level of concentration as CMC L and CMC H: 2% Chitosan (w/v) was dissolved in deionized (DI) water with 1% acetic acid, 25% glycerol (w/chitosan dry weight) and 0.15% Tween 20 (w/v); The edible coating solutions were homogenized for 2 min at 5,000 rpm in a homogenizer (Model Kinematica Politron pt-2500 E, Bohemia, N.Y.) and stored overnight at 4° C. before use. Two levels of 911 powder edible coatings were also used. The amount of powder deposited onto the raspberries surface was 1.5 and 3% based on weight of raspberries. These powder coatings levels were identified as 911 L and 911 H.

Raspberries were weighed before and after treatments to determine the approximate coating weight. For berries coated with SA, CMC, and chitosan, the raspberries were placed on a stainless-steel wired tray and manually sprayed until they were fully covered by the coating solution. A sprayer (model Continental Spray Pro Trigger 902RW9, China) was used for spraying the solution. After coating, the excess coating solution was removed by air drying at room temperature (24° C.) in an air-circulated drier for 30 min at 2 m/s.

The 911 powder was applied to raspberries as follows: frozen berries were randomly placed on a 3-inch stainless-steel mesh number 10, 2000 microns (ATM Corporation, Milwaukee, Wis.), and the pan and berries were weighted. Second, the powder was sprinkled over the raspberries until the amount of coating remaining adhered to the surface of the raspberries. The adherence was confirmed by weighting the pan with the berries again. Between the mentioned steps, the sieve was carefully cleaned to remove the excess coating that adhered to the mesh.

### Freezing

Next, the raspberries were carefully placed into glass jars. The jars were closed and cooled at 4° C. for two hours and then transferred to an air blast freezer at −35° C. and stored for two months. After storage, the berries were thawed. The berries were also used for baking. In general, a few berries were placed in each container during freezing to minimize their contact and avoid damage while handling.

### Weight Loss and Drip Loss Analysis, Mechanical Properties

For weight loss analysis, the fresh and coated raspberries were placed on ventilated trays at 4° C. Weight loss was measured by monitoring the weight changes of the fruit for 5 days. Weight loss was calculated as a percentage of initial weight. Three replicates were used. Ten berries were used for each measurement.

For the drip loss analysis, the frozen berries were removed from jars after 6 h of thawing, and the jars were weighted again. The weight change before and after thawing was the drip loss result.

Frozen berries were allowed to thaw inside glass jars at 24° C. for 6 h. before the mechanical properties' analysis. The mechanical properties of berries were determined with a texture profile analyzer (Model TA-XT2, Stable Microsystems, Godalming, England) by measuring the maximum force (FM) and the gradient (G_{C}). A compression test with 80% strain was performed with a 25 kg load cell and a flat cylinder probe of 50 mm diameter at a constant plunger speed of 0.5 mm/s. The berries were centrally placed, with their major axis perpendicular to the compression plate. Ten berries were used per experiment, and each experiment was performed three times.

### Baking

Muffin batter containing the following ingredients was prepared: all-purpose enriched, bleached, and pre-sifted wheat flour (General Mills, Inc., Minneapolis, Minn., USA); eggs (Wilcox Family Farm, Roy, Wash., USA); pure cane sugar (Domino Foods, Inc., Yonkers, N.Y., USA); pure vegetable oil (Long Life brand, Incobrasa Industries, LTD, Gilman, Ill., USA); Nonfat Instant Dry milk (Great Value, Wal-Mart Stores Inc., Bentonville, Ark., USA); baking powder (Clabber Girl, Clabber Girl Corporation, Terre Haute, Ind., USA); salt (IGA brand, IGA Inc., Chicago, Ill., USA); and water. (See Table 4). The ingredients were mixed at room temperature for 45 s.

TABLE 4
Muffin dough ingredients. One raspberry
was placed per muffin. The raspberry weighing
between 1.5 and 2.5 g per muffin

| Ingredient | (%) |
|---|---|
| Fruit | — |
| Wheat flour | 33.64 |
| Eggs | 10.10 |
| Sugar | 16.82 |
| Vegetable oil | 13.45 |
| Milk | 3.06 |
| Water | 20.48 |
| Baking powder | 2.00 |
| Salt | 0.45 |
| Total | 100 |

Raspberries commercially frozen or previously treated with at least one of the treatments were incorporated into the muffins and baked to evaluate the effects of vacuum impregnation, partial drying and edible coating treatments. Twenty-five grams of batter was poured into each of six paper muffin cups (63 mm top diameter×30 mm depth; Reynolds Metals Company, Richmond, Va., USA), and one frozen-thawed berry was placed into the batter. Another 25 g of batter was added to complete the muffin preparation, and muffins were baked in an oven (Frigidaire, Pittsburgh, Pa.) at 204° C. for 20 min. Three replicates were used. Each replicate with ten samples of each fruit treatment. After baking, the muffins were loosely covered with aluminum foil and cooled at temperature of 4° C. for 3 h. Then the muffins were transversally cut in halves and photographed. The camera (Canon EOS 60D with 18.1 megapixels resolution Japan) used had a Canon EF 100 mm f/2.8 USM Macro lens with two lights. (ALZO 27W, USA). The camera was connected to a computer. The images were analyzed through the image software program ImageJ 1.46r. Two methods to determine fruit and bleeding areas were selected: intensity threshold and line selection freehand.

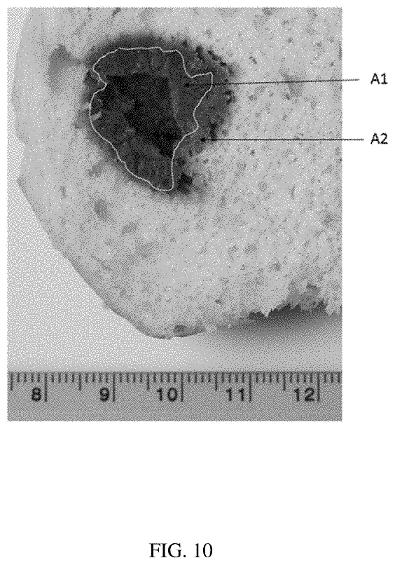

Syneresis of the baked fruit for different treatments was determined using the following procedure; the area surrounding the skin of the fruit was measured in the image of muffins (A₁), and then a second measurement by drawing a perimeter, including the area of the released liquid (A₂) in the muffin. (See FIG. 10). The difference between the areas divided by the area of the released liquid was the percentage of syneresis.

### Statistical Analysis

Analysis of data was performed using SAS 9.2. A completely randomized factorial design with 3 replicates was used. Every replicate involved 10 raspberries. An analysis of variance ANOVA and Fisher's Least Significant Difference test at level of significance of p≤0.05 were used to analyze the difference between means.

### Results and Discussion

Performance of Edible Coatings with Fresh and Partially Dried Berries

The drip loss of frozen thawed control berries was significantly (p≤0.05) higher than the drip loss of the frozen thawed coated berries. This suggests that edible coatings can help maintain moisture in frozen and thawed berries. A decrease in drip loss was also observed with partially dried and coated berries in comparison to either control sample. In particular, the application of CMC at both concentrations and SA coatings at low concentration resulted in berries with better performance in terms of drip loss.

The mechanical properties (F_{M} and G_{C} values) of the control and the only coated berries were similar. However, F_{M} and G_{C} values of partially dehydrated (PD) raspberries were higher than the F_{M} and G_{C} values of control and only coated berries. Results show that an increase in maximum force and gradient was noticed in partially dried and coated fruit when compared with only coated berries. Again, CMC at both concentrations and SA coatings at a low concentration on partially dehydrated raspberries resulted in higher F_{M} and G_{C} values than those values at any other combination of treatments. (Table 5).

TABLE 5
Influence of different coatings on mechanical properties and drip loss in frozen/thawed red raspberries.

| | | | Coated (EC) | | | Partially dried (PD)-Coated (EC) | | |
|---|---|---|---|---|---|---|---|---|
| | | | | Mechanical properties | | | Mechanical properties | |
| | Concentration | Approximate | | F_{M} | G_{C} | | F_{M} | G_{C} |
| Label | (%) | coating² (g) | Drip loss (%) | (N) | (N/mm) | Drip loss (%) | (N) | (N/mm) |
| ¹Control | — | — | 4.27 ± 0.35^{a} | 7.45 ± 0.29^{a} | 2.06 ± 0.39^{a} | 4.27 ± 0.35^{a} | 7.45 ± 0.29^{d} | 2.06 ± 0.39^{f} |
| PD | — | — | — | — | — | 1.45 ± 0.07^{d} | 16.76 ± 0.49^{a} | 5.19 ± 0.29^{abc} |
| CMCL | 0.05 | 0.5 to 0.6 | 2.81 ± 0.34^{c} | 7.75 ± 1.18^{a} | 1.47 ± 0.39^{a} | 1.45 ± 0.13^{d} | 16.86 ± 0.39^{a} | 5.98 ± 0.88^{a} |
| CMCH | 0.1 | 0.4 to 0.5 | 2.52 ± 0.57^{c} | 7.05 ± 0.98^{ab} | 1.76 ± 0.39^{a} | 1.84 ± 0.22^{c} | 15.78 ± 1.08^{a} | 5.19 ± 0.29^{abc} |
| SA L | 0.4 | 0.4 to 0.5 | 2.72 ± 0.37^{c} | 6.67 ± 1.08^{b} | 1.76 ± 0.67^{a} | 1.26 ± 0.35^{d} | 16.17 ± 0.98^{a} | 5.39 ± 0.39^{ab} |
| SA H | 1 | 0.5 to 0.6 | 3.22 ± 0.40^{b} | 4.31 ± 0.49^{c} | 1.47 ± 1.08^{a} | 2.31 ± 0.47^{c} | 12.74 ± 1.27^{b} | 3.82 ± 0.69^{de} |
| Chitosan | 2 | 0.4 to 0.5 | 3.34 ± 0.12^{b} | 4.61 ± 1.18^{c} | 1.57 ± 0.39^{a} | 3.21 ± 0.18^{b} | 9.01 ± 1.27^{c} | 4.61 ± 0.59^{cd} |
| 911 L | 1.5 | 0.3 to 0.4 | 2.94 ± 0.62^{bc} | 4.11 ± 1.17^{c} | 1.96 ± 0.78^{a} | 2.35 ± 0.33^{c} | 12.64 ± 1.57^{b} | 3.92 ± 0.59^{d} |
| 911 H | 3 | 0.4 to 0.5 | 3.07 ± 0.41^{b} | 5.10 ± 0.59^{c} | 1.86 ± 0.59^{a} | 2.25 ± 0.27^{c} | 12.94 ± 1.18^{b} | 3.82 ± 0.29^{e} |

¹Control frozen-thawed samples were not coated nor dried. Approximate weight of coating per raspberry. PD partially dehydrated raspberries were dried at 0.65 g H₂O/g fruit and then frozen. The drip loss and textural characteristics of dried and non-dried raspberries were determined after freezing thawing. Means within a column followed by the same letters are not significantly different at p ≥0.05. Results reported are mean ± SD. Three replicates were used. Every replicate involved 10 raspberries

In addition, the use of chitosan and SA at high concentration and 911 at both concentrations on partially dehydrated and coated berries produced poor results in terms of mechanical properties and drip loss. Therefore, these latter four coatings solutions were not considered in following studies.

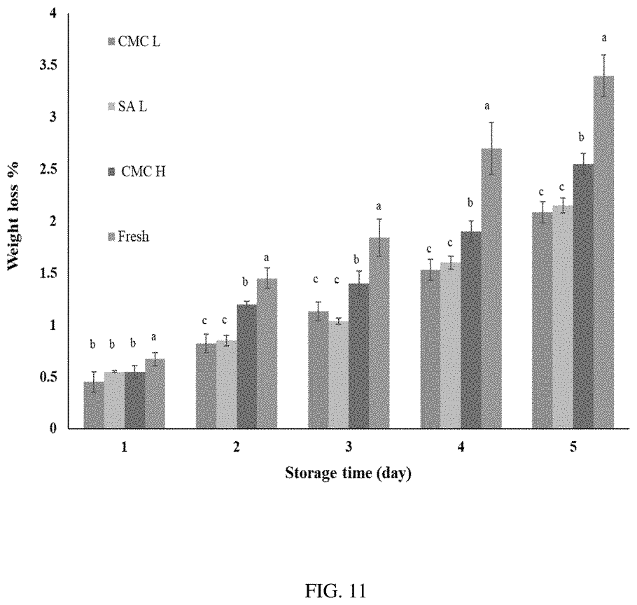

The weight loss of both fresh and coated berries increased with time during refrigerated storage. However, the fresh berries showed higher weight loss compared to other samples (FIG. 11). The data suggest that edible coatings can help reduce the weight loss in berries during storage.

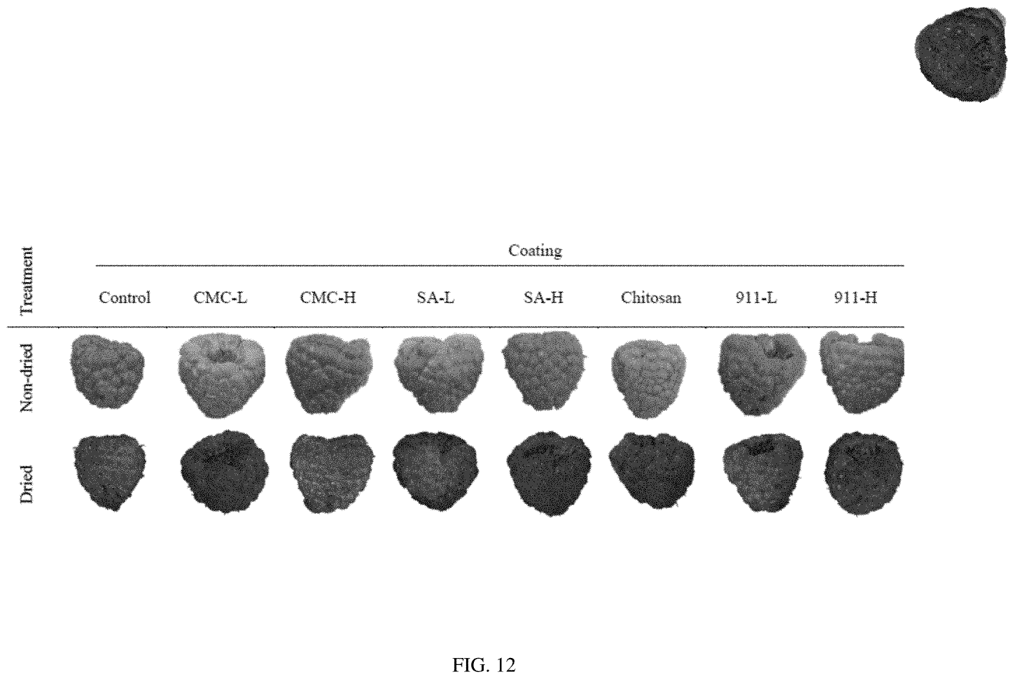

Results show no difference between the visual appearance and integrity of the control non dried, and the coated non-dried raspberries. No noticeable change in color was observed in the partially dried control and the partially dried coated berries. A change in raspberry structure caused by drying was evident. (FIG. 12). Results also show that partial dehydration of berries before coating created changes in color and visual integrity compared to only coated berries.

Performance of Edible Coatings with Vacuum Impregnated and Partially Dehydrated Berries

This study compared the performance indices of VI, PD, VI-PD, and VI-PD-EC. Also compares the benefits of applying VI-PD-EC vs PD-EC treatment. There was no difference in visual integrity and color between frozen thawed control and VI berries. The visual quality of both control and VI berries was better than the partially dehydrated berries. Once again, some changes in berry color and structure was apparent due to the drying process.

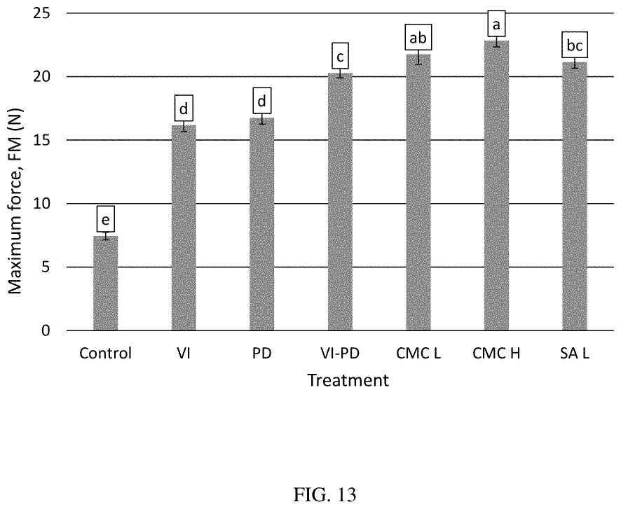

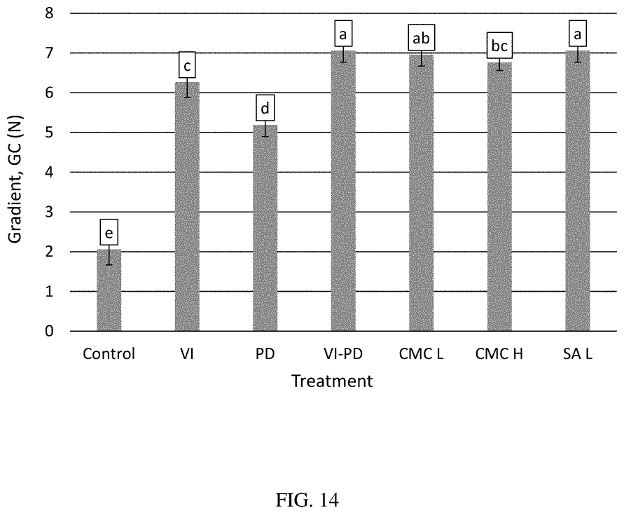

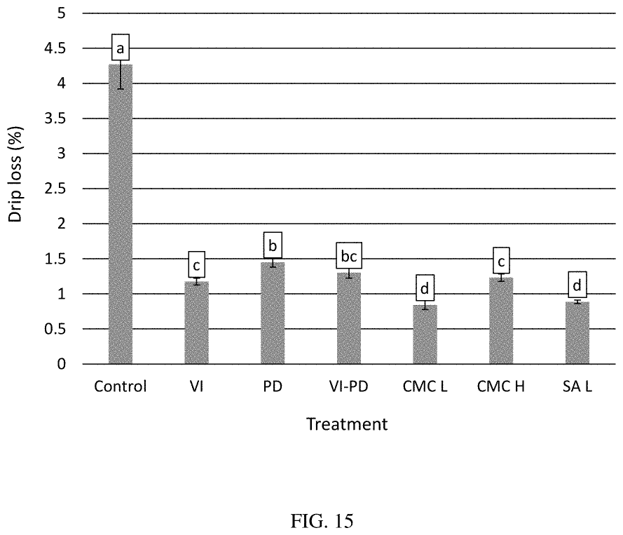

Each treatment, e.g., VI, PD and VI-PD-EC individually improved the mechanical properties compared to control berries. The combination of VI-PD further improved firmness in thawed berries. In general, the application of the VI-PD-EC did not improve the mechanical properties further (FIGS. 13 and 14). However, treated berries with VI, PD, VI-PD, and VI-PD-EC reduced drip loss significantly (p≤0.05) compared to control berries (FIG. 15). Results clearly indicate the benefits of impregnation, drying and coating in reducing the bleeding of juice and improving mechanical properties when compared with partially dried and coated frozen thawed berries (Table 6).

TABLE 6
Influence of coatings on the mechanical properties and drip loss of vacuum
impregnated partially dehydrated and coated of frozen/thawed red raspberries

| | | | | | | Vac. impregnated (VI)- | | |
|---|---|---|---|---|---|---|---|---|
| | | | Partially dried (PD)-Coated (EC) | | | dried (PD)-coated (EC) | | |
| | | | | Mechanical properties | | | Mechanical properties | |
| | Concentration | Approximate | | F_{M} | G_{C} | | F_{M} | G_{C} |
| Label | (%) | coating² (g) | Drip loss (%) | (N) | (N/mm) | Drip loss (%) | (N) | (N/mm) |
| ¹Control | — | — | 4.27 ± 0.35^{a} | 7.45 ± 0.29^{b} | 2.06 ± 0.39^{b} | 4.27 ± 0.35^{a} | 7.45 ± 0.29^{e} | 2.06 ± 0.39^{e} |
| VI | — | — | — | — | — | 1.17 ± 0.05^{c} | 16.17 ± 0.49^{d} | 6.27 ± 0.39^{c} |
| PD | — | — | 1.45 ± 0.07^{c} | 16.76 ± 0.49^{a} | 5.19 ± 0.29^{a} | 1.45 ± 0.07^{b} | 16.76 ± 0.49^{d} | 5.19 ± 0.29^{d} |
| VI-PD | — | — | — | — | — | 1.30 ± 0.08^{bc} | 20.29 ± 0.39^{c} | 7.06 ± 0.29^{a} |
| CMCL | 0.05 | 0.5 to 0.6 | 1.45 ± 0.13^{c} | 16.86 ± 0.39^{a} | 5.98 ± 0.88^{a} | 0.84 ± 0.07^{d} | 21.76 ± 0.78^{ab} | 6.96 ± 0.29^{ab} |
| CMCH | 0.1 | 0.4 to 0.5 | 1.84 ± 0.22^{b} | 15.78 ± 1.08^{a} | 5.19 ± 0.29^{a} | 1.23 ± 0.05^{c} | 22.83 ± 0.49^{a} | 6.76 ± 0.20^{bc} |
| SA L | 0.4 | 0.4 to 0.5 | 1.26 ± 0.35^{c} | 16.17 ± 0.98^{a} | 5.39 ± 0.39^{a} | 0.89 ± 0.03^{d} | 21.16 ± 0.49^{bc} | 7.06 ± 0.29^{a} |

¹Control frozen-thawed samples were not coated nor dried. Approximate weight of coating per raspberry. VI vacuum impregnated raspberries. VI-PD vacuum impregnated and dehydrated raspberries. The drip loss and textural characteristics of raspberries were determined after freezing thawing. Means within a column followed by the same letters are not significantly different at p ≥0.05. Results reported are mean ± SD. Three replicates were used. Every replicate involved 10 raspberries

### Evaluation of the Tendency to Syneresis in Baked Stable Raspberries Preparations

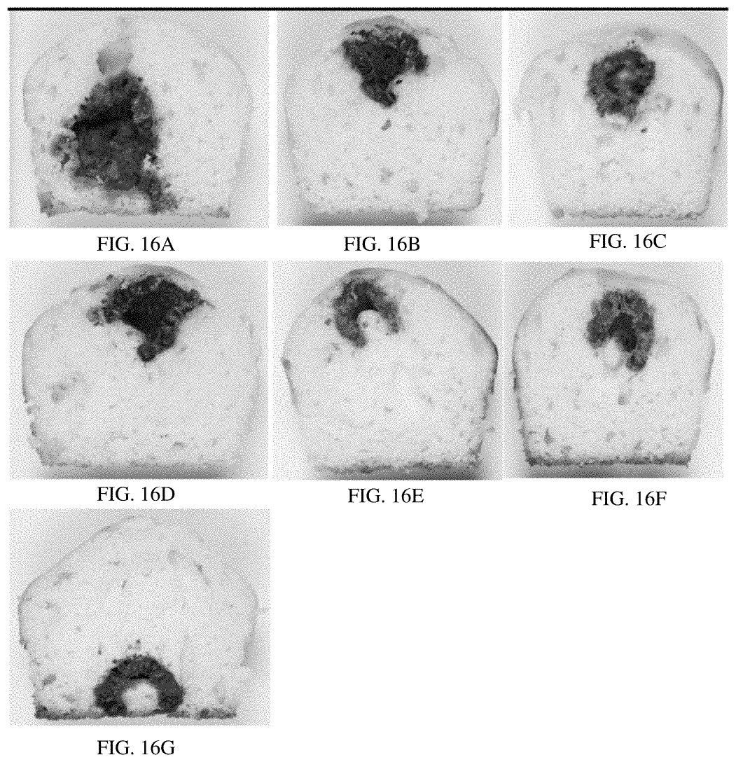

The baking trials indicated that berries subjected to VI-PD-EC with CMC at two concentrations and SA at low concentration lowered syneresis compared that of berries treated with VI or PD alone or combination of these two treatments (Table 7). These observations are consistent with reports in literature. Alginate is an excellent gel former in the presence of multivalent cations, a formation that is almost independent of temperature. In the absence of soluble solids, the importance of gelation from the interaction with calcium ions in bakery fillings has been reported. CMC is also an excellent hydrocolloid derivative from cellulose. The major applications of CMC are in the area of water binding. CMC has been found to be a good contributor to the stabilization of frozen products, inhibiting ice crystal formation and resisting dripping. In our study, the commercial frozen berries showed higher syneresis than that of treated berries (FIG. 16).

TABLE 7
Syneresis in muffins containing frozen- thawed raspberry after
baking.

| Treatment | Syneresis (%) |
|---|---|
| Commercially Frozen | 62.9 ± 3.8^{a} |
| VI | 42.6 ± 1.9^{b} |
| VI-PD | 31.5 ± 1.1^{c} |
| PD | 29.6 ± 2.5^{c} |
| VI-PD-EC with CMC L | 18.1 ± 1.1^{d} |
| VI-PD-EC with CMC H | 16.0 ± 2.8^{d} |
| VI-PD-EC with SA L | 13.9 ± 2.8^{e} |

VI vacuum impregnation only; VI-PD vacuum impregnation and partial drying; PD partial drying only; VI-PD-EC vacuum impregnation, partial drying and edible coating. Means within a column followed by the same letters are not significantly different at p ≤ 0.05. Results reported are mean ± SD. Three replicates were used. Every replicate involved ten samples of each fruit treatment.

### Conclusions

Findings of this study demonstrate that combining different process and technologies such as vacuum impregnation, partial drying and edible coating may be beneficial for the development of baking stable red raspberries. Both SA and CMC at low concentrations were found to be effective in minimizing the syneresis in raspberries during baking. Vacuum impregnation, partial drying and edible coating alone improved the mechanical properties and drip loss. However, combining all three pretreatments resulted in a synergetic effect in producing the baking stable berries.

The optimal treatment conditions were: an infusion solution at 20° C. containing LMP concentration of 1% (w/w) and 0.035 mg of CaCl₂.2H₂O per g of pectin, at 50.8 kPa abs, for 7 and 5 min, vacuum and restoration time respectively; air drying at 65° C. and air velocity 1.5 m/s until water content of 0.65 g of H₂O/g of fruit; and coating with SA at low concentration of alginate at 0.4% (w/v).

### REFERENCES

[1] USDA. 2015. USDA National Nutrient Database for Standard Reference (Release 28). U.S. Department of Agriculture, Agricultural Research Service, USDA Nutrient Data Laboratory.
[2] Wada, L.; Ou, B. Antioxidant Activity and Phenolic Content of Oregon Caneberries. J. Agric. Food Chem. 2002, 50, 3495-3500. DOI: 10.1021/jf0114051.
[3] Moreiras, O.; Carbajal, A.; Cabrera, L.; Cuadrado, C. Tabla de Composicion de los Alimentos; Madrid: Ediciones Piramide (Grupo Anaya), 2001.
[4] Joles, D. W.; Cameron, A. C.; Shirazi, A.; Petracek, P. D.; Beaudry, R. M. Modified-Atmosphere Packaging of ‘Heritage’ Red Raspberry Fruit: Respiratory Response to Reduced Oxygen, Enhanced Carbon Dioxide, and Temperature. J. Am. Soc. Horticult. Sci. 1994, 119, 540-545. DOI: 10.21273/JASHS.119.3.540.
[5] Torreggiani, D. Technological Aspects of Osmotic Dehydration in Foods. In Food Preservation by Moisture Control: Fundamentals and Applications, ISOPOW PRACTICUM II; Barbosa-Canovas, G. V., Welti-Chanes, J., Eds.; Lancaster: Technomic Pub Co Inc., 1995; pp 281-304.
[6] Talens, P.; Escriche, I.; Martinez-Navarrete, N.; Chiralt, A. Study of the Influence of Osmotic Dehydration and Freezing on the Volatile Profile of Strawberries. J. Food Sci. 2002, 67, 1648-1653. DOI: 10.1111/j.1365-2621.2002.tb08699.x.
[7] Hajji, W.; Gliguem, H.; Bellagha, S.; Allaf, K. Impact of Initial Moisture Content Levels, Freezing Rate and Instant Controlled Pressure Drop Treatment (DIC) on Dehydrofreezing Process and Quality Attributes of Quince Fruits. Drying Technol. 2019, 37, 1028-1043. DOI: 10.1080/07373937.2018.1481867.
[8] Xu, B.; Zhang, M.; Bhandari, B.; Cheng, X. Influence of Ultrasound-Assisted Osmotic Dehydration and Freezing on the Water State, Cell Structure, and Quality of Radish (Raphanus sativus L.) Cylinders. Drying Technol. 2014, 32, 1803-1811. DOI: 10.1080/07373937.2014.947427.
[9] Sette, P.; Salvatori, D.; Schebor, C. Physical and Mechanical Properties of Raspberries Subjected to Osmotic Dehydration and Further Dehydration by Air- and Freeze-Drying. Food Bioprod. Process. 2016, 100, 156-171. DOI: 10.1016/j.fbp.2016.06.018.
[10] Forni, E.; Sormani, A.; Scalise, S.; Torreggiani, D. The Influence of Sugar Composition on the Colour Stability of Osmodehydrofrozen Intermediate Moisture Apricots. Food Res. Int. 1997, 30, 87-94. DOI: 10.1016/S0963-9969(97)00038-0.
[11] Maestrelli, A.; Lo Scalzo, R.; Lupi, D.; Bertolo, G.; Torreggiani, D. Partial Removal of Water before Freezing: cultivar and Pre-Treatments as Quality Factors of Frozen Muskmelon (Cucumis melo, cv reticulatus Naud.). J. Food Eng. 2001, 49, 255-260. DOI: 10.1016/S0260-8774(00)00211-9.
[12] Sormani, A.; Maffi, D.; Bertolo, G.; Torreggiani, D. Textural and Structural Changes of Dehydrofreeze-Thawed Strawberry Slices: Effects of Different Dehydration Pretreatments/Cambios Texturales y Estructurales de Rodajas de Fresa Deshidratadas y Descongeladas: Efectos de Diferentes Pretratamientos de Deshidrataci_on. Food Sci. Technol. Int. 1999, 5, 479-485. DOI: 10.1177/108201329900500605.
[13] Ramallo, L.; Mascheroni, R. Dehydrofreezing of Pineapple. J. Food Eng. 2010, 99, 269-275. DOI: 10. 1016/j.jfoodeng.2010.02.026.
[14] Quintanilla, A.; Mencia, A.; Powers, J.; Rasco, B.; Tang, J.; Sablani, S. S. Vacuum Impregnation of Firming Agents in Red Raspberries. J. Sci. Food Agric. 2018, 98, 3706-3714. DOI: 10.1002/jsfa.8878.
[15] Radziejewska-Kubzdela, E.; Biega_nska-Marecik, R.; Kido_n, M. Applicability of Vacuum Impregnation to Modify Physico-Chemical, Sensory and Nutritive Characteristics of Plant Origin Products—A Review. Int. J. Mol. Sci. 2014, 15, 16577-16610. DOI: 10. 3390/ijms150916577.
[16] Thakur, B. R.; Singh, R. K.; Handa, A. K.; Rao, M. A. Chemistry and Uses of Pectin—A Review. Crit. Rev. Food Sci. Nutr. 1997, 37, 47-73. DOI: 10. 1080/10408399709527767.
[17] Reno, M. J.; Prado, M. E.; Resende, J. V. Microstructural Changes of Frozen Strawberries Submitted to Pre-Treatments with Additives and Vacuum Impregnation. Ci\hat{ }enc. Tecnol. Aliment. 2011, 31, 247-256. DOI: 10.1590/S0101-20612011000100038.
[18] Alonso, J.; Rodriguez, T.; Canet, W. Effect of Calcium Pretreatments on the Texture of Frozen Cherries. Role of Pectinesterase in the Changes in the Pectic Materials. J. Agric. Food Chem. 1995, 43, 1011-1016. DOI: 10.1021/jf00052a031.
[19] Mart_mez-Navarrete, N.; Moraga, G.; Mart_mez-Monz_o, J.; Botella, F.; Tirado, N.; Chiralt, A. Mechanical and Color Changes Associated to Dehydrofreezing of Strawberry. In Proceedings of the International Congress on Engineering and Food. ICEF-8; Welti-Chanes, J., Barbosa-Canovas, G. V., Aguilera, J. M., Eds.; Lancaster: Technomic Publisher, 2001; pp. 793-797.
[20] Van Buren, J.; Joslyn, M. A. Current Concepts on the Texture of Fruits and Vegetables. CRC Crit. Rev. Food Technol. 1970, 1, 5-24. DOI: 10.1080/10408397009527098.
[21] Moyano, P. C.; Vega, R. E.; Bunger, A.; Garret_on, J.; Osorio, F. A. Effect of Combined Processes of Osmotic Dehydration and Freezing on Papaya Preservation. Food Sci. Technol. Int. 2002, 8, 295-301. DOI: 10.1177/1082013202008005183.
[22] James, C.; Purnell, G.; James, S. A Critical Review of Dehydrofreezing of Fruits and Vegetables. Food Bioprocess Technol. 2014, 7, 1219-1234. DOI: 10. 1007/s11947-014-1293-y.
[23] Chassagne-Berces, S.; Poirier, C.; Devaux, M. F.; Fonseca, F.; Lahaye, M.; Pigorini, G.; Girault, C.; Marin, M.; Guillon, F. Changes in Texture, Cellular Structure and Cell Wall Composition in Apple Tissue as a Result of Freezing. Food Res. Int. 2009, 42, 788-797. DOI: 10.1016/j.foodres.2009.03.001.
[24] Delgado, A. E.; Rubiolo, A. C. Microstructural Changes in Strawberry after Freezing and Thawing Processes. LWT Food Sci. Technol. 2005, 38, 135-142. DOI: 10.1016/j.lwt.2004.04.015.
[25] Allan-Wojtas, P.; Goff, H. D.; Stark, R.; Carbyn, S. The Effect of Freezing Method and Frozen Storage Conditions on the Microstructure of Wild Blueberries as Observed by Cold-Stage Scanning Electron Microscopy (Cryo-SEM). Scanning 2006, 21, 334-347. DOI: 10.1002/sca.4950210507.
[26] Oduse, K. A.; Cullen, D. An Investigation into the Fruit Firmness Properties of Some Progeny and Cultivars of Red Raspberry (Rubus idaeus). IOSR J. Environ. Sci. Toxicol. Food Technol. 2012, 1, 4-12. DOI: 10.9790/2402-0160412.
[27] Summen, M. A.; Erge, H. S. Thermal Degradation Kinetics of Bioactive Compounds and Visual Color in Raspberry Pulp. J. Food Process. Preserv. 2014, 38, 551-557. DOI: 10.1111/jfpp.12002.
[28] Bonat Celli, G.; Ghanem, A.; Su-Ling Brooks, M. Influence of Freezing Process and Frozen Storage on the Quality of Fruits Products. Food Rev. Int. 2016, 32, 280-304. DOI: 10.1080/87559129.2015.1075212.
[29] Sette, P. A.; Franceschinis, L. E.; Schebor, C.; Salvatori, D. Osmotic Dehydrated Raspberries: changes in Physical Aspects and Bioactive Compounds. Drying Technol. 2015, 33, 659-670. DOI: 10.1080/07373937.2014.971123.
[30] Bunger, A.; Moyano, P. C.; Vega, R. E.; Guerrero, P.; Osorio, F. Osmotic Dehydration and Freezing as Combined Processes on Apple Preservation. Food Sci. Technol. Int. 2004, 10, 163-170. DOI: 10.1177/1082013204044828.
[31] Sapers, G. M.; Burgher, A. M.; Phillips, J. G.; Jones, S. B.; Stone, E. Effects of Freezing, Thawing, and Cooking on the Appearance of Highbush Blueberries. J. Am. Soc. Horticult. Sci. 1984, 109, 112-117.

While the invention has been described in terms of its several exemplary embodiments, those skilled in the art will recognize that the invention can be practiced with modification within the spirit and scope of the appended claims. Accordingly, the present invention should not be limited to the embodiments as described above, but should further include all modifications and equivalents thereof within the spirit and scope of the description provided herein.

We claim:

1. A method of stabilizing produce, comprising:
submerging an item of produce in an infusion solution comprising a polysaccharide and a divalent cation;
applying a vacuum to the infusion solution containing the item of produce;
releasing the vacuum applied to the infusion solution;
removing the item of produce from the infusion solution;
drying the item of produce after infusion so as to reduce a water content of the item of produce below an original harvest-level of hydration of the item of produce; and
applying an edible coating to the item of produce.

2. The method of claim 1, wherein the polysaccharide is low methoxyl pectin (LMP).

3. The method of claim 2, wherein the LMP is present at a concentration of 0.8-1.2% w/w.

4. The method of claim 1, wherein the divalent cation is calcium.

5. The method of claim 4, wherein the calcium is present at a concentration of 0.025-0.040 mg per g of polysaccharide.

6. The method of claim 1, wherein the infusion solution is maintained at a temperature of 18-22° C. during the applying step.

7. The method of claim 1, wherein during the drying step the item of produce is air dried at a temperature of 62-68° C. and an air velocity of at least 1.3 m/s.

8. The method of claim 1, wherein the edible coating comprises sodium alginate or sodium carboxymethylcellulose.

9. The method of claim 8, wherein the sodium alginate is at a concentration of 0.2-0.6% w/v.

10. The method of claim 8, wherein the sodium carboxymethylcellulose is at a concentration of 0.03-0.07% w/v.

11. The method of claim 1, further comprising a step of air blast freezing the item of produce to a temperature at or below −18° C. after applying the edible coating.

12. The method of claim 1, wherein the item of produce is stabilized for at least two months.

13. A method of stabilizing produce, comprising:
submerging an item of produce in an infusion solution comprising a polysaccharide and a divalent cation;
applying a vacuum to the infusion solution containing the item of produce;
releasing the vacuum applied to the infusion solution;
removing the item of produce from the infusion solution;
drying the item of produce after infusion so as to reduce a water content of the item of produce below an original harvest-level of hydration of the item of produce; and
air blast freezing the item of produce.

14. The method of claim 13, wherein the polysaccharide is low methoxyl pectin (LMP).

15. The method of claim 14, wherein the LMP is present at a concentration of 0.8-1.2% w/w.

16. The method of claim 13, wherein the divalent cation is calcium.

17. The method of claim 16, wherein the calcium is present at a concentration of 0.025-0.040 mg per g of polysaccharide.

18. The method of claim 13, wherein the infusion solution is maintained at a temperature of 18-22° C. during the applying step.

19. The method of claim 13, wherein during the drying step the item of produce is air dried at a temperature of 62-68° C. and an air velocity of at least 1.3 m/s.

20. The method of claim 13, further comprising a step of applying an edible coating to the item of produce prior to air blast freezing.

21. The method of claim 20, wherein the edible coating comprises sodium alginate or sodium carboxymethylcellulose.

22. The method of claim 21, wherein the sodium alginate is at a concentration of 0.2-0.6% w/v.

23. The method of claim 21, wherein the sodium carboxymethylcellulose is at a concentration of 0.03-0.07% w/v.

24. The method of claim 13, wherein the item of produce is frozen to a temperature at or below −18° C.
